(19) United States
(12) Patent Application Publication
(10) Pub. No.: US 2023/0308962 A1
(43) Pub. Date: Sep. 28, 2023

(54) METHOD AND APPARATUS FOR FAILURE HANDLING IN SERVING CELL CHANGE IN A WIRELESS COMMUNICATION SYSTEM

(71) Applicant: ASUSTek Computer Inc., Taipei City 112 (TW)

(72) Inventors: Yi-Hsuan Kung, Taipei City (TW); Yu-Hsuan Guo, Taipei City (TW)

(21) Appl. No.: 18/126,109

(22) Filed: Mar. 24, 2023

Related U.S. Application Data
(60) Provisional application No. 63/324,601, filed on Mar. 28, 2022.
(60) Provisional application No. 63/324,612, filed on Mar. 28, 2022.
(60) Provisional application No. 63/324,620, filed on Mar. 28, 2022.

(51) Int. Cl. H04W 36/00; H04W 36/24

(52) U.S. Cl. CPC H04W 36/0079; H04W 36/0064; H04W 36/249; H04W 36/00835

(57) ABSTRACT

A method for a User Equipment (UE) in a wireless communication system can comprise receiving, from a first cell, a first signaling indicative of a configuration of at least a second cell, receiving, from the first cell, a second signaling to switch a Special Cell (SpCell) of the UE to the second cell, wherein the second signaling comprises at least one of a Physical Downlink Control Channel (PDCCH) signaling or a Medium Access Control (MAC) Control Element (CE), performing a procedure to switch the SpCell of the UE in response to the second signaling, performing one or more actions in response to detecting a failure of the procedure, including: initiating a random access procedure on the second cell, transmitting a report to a network of the first cell, wherein the report indicates the unsuccessful switching of the SpCell to the second cell, or initiating a RRC connection re-establishment procedure.

### CROSS-REFERENCE TO RELATED APPLICATIONS

The present application claims priority to and the benefit of U.S. Provisional Patent Application Ser. No. 63/324,601, filed Mar. 28, 2022, U.S. Provisional Patent Application Ser. No. 63/324,612, filed Mar. 28, 2022, and U.S. Provisional Patent Application Ser. No. 63/324,620, filed Mar. 28, 2022; with each of the referenced applications and disclosures fully incorporated herein by reference.

### FIELD

This disclosure generally relates to wireless communication networks and, more particularly, to a method and apparatus for failure handling in serving cell change in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

Methods, systems, and apparatuses are provided for handling failure cases for Serving Cell change in L1/L2 mobility procedures. In various embodiments, a method for a User Equipment (UE) in a wireless communication system comprises receiving, from a first cell, a first signaling indicative of a configuration of at least a second cell, receiving, from the first cell, a second signaling to switch a Special Cell (SpCell) of the UE to the second cell, wherein the second signaling comprises at least one of a Physical Downlink Control Channel (PDCCH) signaling or a Medium Access Control (MAC) Control Element (CE), performing a procedure to switch the SpCell of the UE in response to the second signaling, performing one or more actions in response to detecting a failure of the procedure, including: initiating a random access procedure on the second cell, transmitting a report to a network of the first cell, wherein the report indicates the unsuccessful switching of the SpCell to the second cell, or initiating a RRC connection re-establishment procedure.

### BRIEF DESCRIPTION OF THE DRAWINGS

FIG. 1 shows a diagram of a wireless communication system, in accordance with embodiments of the present invention.

FIG. 2 is a block diagram of a transmitter system (also known as access network) and a receiver system (also known as user equipment or UE), in accordance with embodiments of the present invention.

FIG. 3 is a functional block diagram of a communication system, in accordance with embodiments of the present invention.

FIG. 4 is a functional block diagram of the program code of FIG. 3, in accordance with embodiments of the present invention.

FIG. 5 is a reproduction of FIG. 5.3.7.1-1: RRC connection re-establishment, successful, from 3GPP specification 38.331 v16.7.0.

FIG. 6 is a reproduction of FIG. 5.3.7.1-2: RRC re-establishment, fallback to RRC establishment, successful, from 3GPP specification 38.331 v16.7.0.

FIG. 7 is a reproduction of FIG. 6.1.3.14-1: TCI States Activation/Deactivation for UE-specific PDSCH MAC CE, from 3GPP specification 38.321 v16.7.0.

FIG. 8 is a reproduction of FIG. 6.1.3.15-1: TCI State Indication for UE-specific PDCCH MAC CE, from 3GPP specification 38.321 v16.7.0.

FIG. 9 is a diagram example showing a UE receiving a first information (e.g., step 1 RRC message) containing cell 1 configuration from Cell 0, in accordance with embodiments of the present invention.

FIG. 10 is a diagram example showing that a UE could be configured with/activated with a Serving Cell 0 (e.g., a SpCell or a Secondary Cell), in accordance with embodiments of the present invention.

FIG. 11 is a diagram example showing that in response to receiving a second information for mobility procedure, the UE initiates/performs a mobility procedure to Cell 1, in accordance with embodiments of the present invention.

FIG. 12 is a diagram example showing that a network associated with the Cell 1 could provide or schedule a UL grant to the UE during or before the mobility procedure indicated by second information from network of the Cell 0, in accordance with embodiments of the present invention.

FIG. 13 is a diagram example showing a UE performing a mobility procedure to Cell 1, in accordance with embodiments of the present invention.

FIG. 14 is a diagram example showing a UE first performing mobility procedure with Cell 1 (indicated by second information from Cell 0), in accordance with embodiments of the present invention.

FIG. 15 is a diagram example showing a UE receiving a second information indicating mobility procedure to Cell 1 from Cell 0 and a UL grant from Cell 0 (could be received in the second information), in accordance with embodiments of the present invention.

FIG. 16 is a diagram example showing a mobility procedure for a UE to switch Primary Cell from Cell 0 to Cell 1, in accordance with embodiments of the present invention.

FIG. 17 is a diagram example showing that a UE could start a timer in response to receiving the second information initiating the mobility procedure, or the UE could start the timer in response to transmission of a mobility completion message, in accordance with embodiments of the present invention.

FIG. 18 is a flow diagram of a UE receiving first and second signaling, initiating a random access procedure, and performing one or more actions in response to unsuccessful completion of a random access procedure, in accordance with embodiments of the present invention.

FIG. 19 is a flow diagram of a UE receiving first and second signaling, monitoring PDCCH of the second cell, and performing one or more actions in response to not receiving a third signaling, in accordance with embodiments of the present invention.

FIG. 20 is a flow diagram of a UE receiving first and second signaling, generating a mobility completion message, transmitting the mobility completion message, and performing one or more actions, in accordance with embodiments of the present invention.

FIG. 21 is a flow diagram of a UE receiving first and second signaling, performing a procedure to switch SpCell, and performing one or more actions in response to detecting a failure of the procedure, in accordance with embodiments of the present invention.

### DETAILED DESCRIPTION

The invention described herein can be applied to or implemented in exemplary wireless communication systems and devices described below. In addition, the invention is described mainly in the context of the 3GPP architecture reference model. However, it is understood that with the disclosed information, one skilled in the art could easily adapt for use and implement aspects of the invention in a 3GPP2 network architecture as well as in other network architectures.

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A (Long Term Evolution Advanced) wireless access, 3GPP2 UMB (Ultra Mobile Broadband), WiMax, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: [1] RP-212710 NR further mobility enhancements; [2] 3GPP specification 38.331 v16.7.0; [3] 3GPP specification 38.321 v16.7.0; and [4] 3GPP specification 38.304 v16.7.0. The standards and documents listed above are hereby expressly and fully incorporated herein by reference in their entirety.

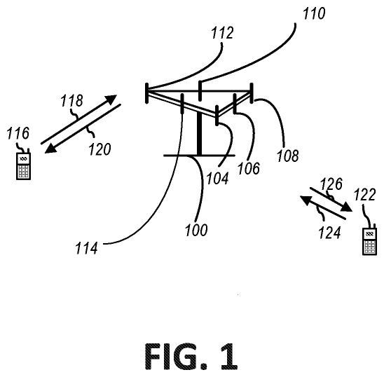

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal (AT) 116 is in communication with antennas 112 and 114, where antennas 112 and 114 transmit information to access terminal 116 over forward link 120 and receive information from AT 116 over reverse link 118. AT 122 is in communication with antennas 106 and 108, where antennas 106 and 108 transmit information to AT 122 over forward link 126 and receive information from AT 122 over reverse link 124. In a FDD system, communication links 118, 120, 124 and 126 may use different frequency for communication. For example, forward link 120 may use a different frequency than that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage normally causes less interference to access terminals in neighboring cells than an access network transmitting through a single antenna to all its access terminals.

The AN may be a fixed station or base station used for communicating with the terminals and may also be referred to as an access point, a Node B, a base station, an enhanced base station, an eNodeB, or some other terminology. The AT may also be called User Equipment (UE), a wireless communication device, terminal, access terminal or some other terminology.

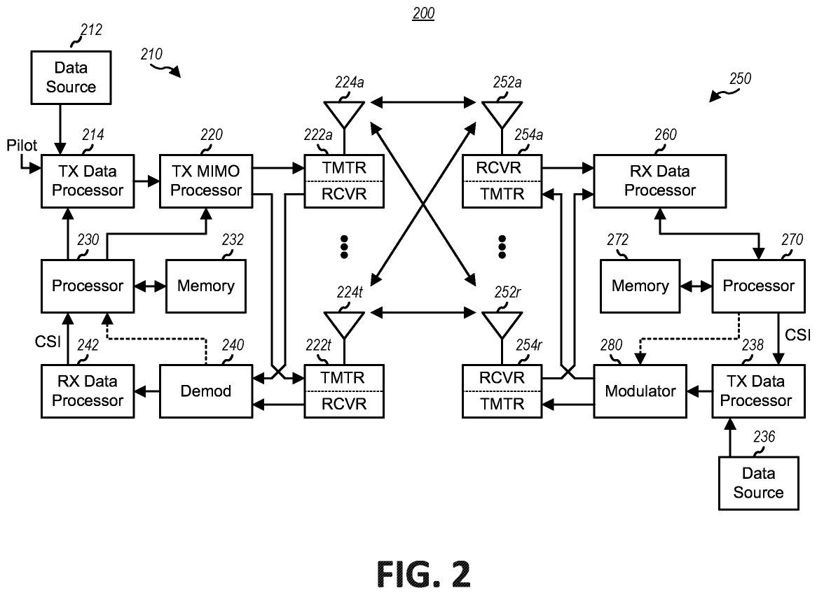

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230. A memory 232 is coupled to processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the NR received symbol streams from NR receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

Memory 232 may be used to temporarily store some buffered/computational data from 240 or 242 through Processor 230, store some buffed data from 212, or store some specific program codes. And Memory 272 may be used to temporarily store some buffered/computational data from 260 through Processor 270, store some buffed data from 236, or store some specific program codes.

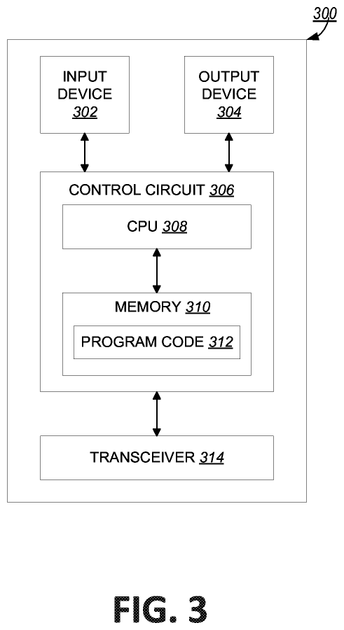

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

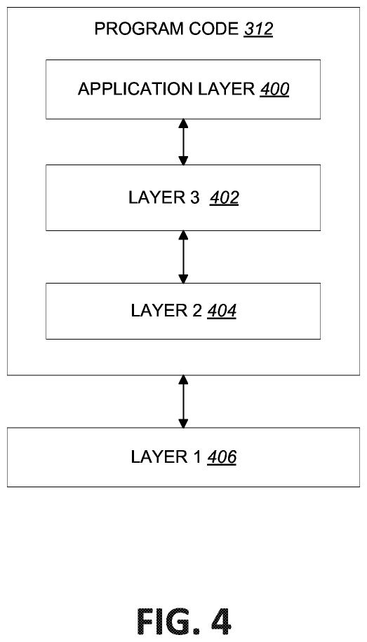

FIG. 4 is a simplified block diagram of the program code 312 shown in FIG. 3 in accordance with an embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

For LTE, LTE-A, or NR systems, the Layer 2 portion 404 may include a Radio Link Control (RLC) layer and a Medium Access Control (MAC) layer. The Layer 3 portion 402 may include a Radio Resource Control (RRC) layer.

Any two or more than two of the following paragraphs, (sub-)bullets, points, actions, or claims described in each invention paragraph or section may be combined logically, reasonably, and properly to form a specific method.

Any sentence, paragraph, (sub-)bullet, point, action, or claim described in each of the following invention paragraphs or sections may be implemented independently and separately to form a specific method or apparatus. Dependency, e.g., “based on”, “more specifically”, “example”, etc., in the following invention disclosure is just one possible embodiment which would not restrict the specific method or apparatus.

In New WID on NR further mobility enhancements ([1] RP-212710 NR further mobility enhancements), objectives for enhancement on mobility for NR are discussed:

3 Justification

When the UE passes from the coverage area of one cell to another cell, at some point a serving cell change need to be performed. Currently serving cell change is triggered by L3 measurements and is done by RRC signalling triggered Reconfiguration with Synch for change of PCell and PSCell, as well as release add for SCells when applicable, all cases with complete L2 (and L1) resets, and involving more latency, more overhead and more interruption time than beam switch mobility. The goal of L1/L2 mobility enhancements is to be able to do serving cell change via L1/L2 signalling with such low latency, low overhead and low interruption time.

4 Objective

4.1 Objective of Core Part WI

The detailed objective of this work item are:
1. To specify mechanism and procedures of L1/L2 based inter-cell mobility for mobility latency reduction:
   Configuration and maintenance for multiple candidate cells to allow fast application of configurations for candidate cells
   Dynamic switch mechanism among candidate serving cells (including SpCell and SCell) for the potential applicable scenarios based on L1/L2 signalling
   L1 enhancements, including inter-cell beam management, L1 measurement and reporting, beam indication, and for non-synchronized scenario to handle TA management
   CU-DU interface signaling to support L1/L2 mobility, if needed

In 3GPP specification 38.331 ([2] 3GPP specification 38.331 v16.7.0), reconfiguration with sync (handover), SCell addition, and connection re-establishment are introduced:

3.1 Definitions

Primary Cell: The MCG cell, operating on the primary frequency, in which the UE either performs the initial connection establishment procedure or initiates the connection re-establishment procedure.

Primary SCG Cell: For dual connectivity operation, the SCG cell in which the UE performs random access when performing the Reconfiguration with Sync procedure.

Secondary Cell: For a UE configured with CA, a cell providing additional radio resources on top of Special Cell.

Secondary Cell Group: For a UE configured with dual connectivity, the subset of serving cells comprising of the PSCell and zero or more secondary cells.

Serving Cell: For a UE in RRC_CONNECTED not configured with CA/DC there is only one serving cell comprising of the primary cell. For a UE in RRC_CONNECTED configured with CA/DC the term ‘serving cells’ is used to denote the set of cells comprising of the Special Cell(s) and all secondary cells.

Special Cell: For Dual Connectivity operation the term Special Cell refers to the PCell of the MCG or the PSCell of the SCG, otherwise the term Special Cell refers to the PCell.

5.3.5.5 Cell Group configuration

5.3.5.5.1 General

The network configures the UE with Master Cell Group (MCG), and zero or one Secondary Cell Group (SCG). In (NG)EN-DC, the MCG is configured as specified in TS 36.331 [10], and for NE-DC, the SCG is configured as specified in TS 36.331 [10]. The network provides the configuration parameters for a cell group in the CellGroupConfig IE.

The UE performs the following actions based on a received CellGroupConfig IE:
1> if the CellGroupConfig contains the spCellConfig with reconfigurationWithSync:
   2> perform Reconfiguration with sync according to 5.3.5.5.2;
   2> resume all suspended radio bearers except the SRBs for the source cell group, and resume SCG transmission for all radio bearers, and resume BH RLC channels and resume SCG transmission for BH RLC channels for IAB-MT, if suspended;
1> if the CellGroupConfig contains the rlc-BearerToReleaseList:
   2> perform RLC bearer release as specified in 5.3.5.5.3;
1> if the CellGroupConfig contains the rlc-BearerToAddModList:
   2> perform the RLC bearer addition/modification as specified in 5.3.5.5.4;
1> if the CellGroupConfig contains the mac-CellGroupConfig:
   2> configure the MAC entity of this cell group as specified in 5.3.5.5.5;
1> if the CellGroupConfig contains the sCellToReleaseList:
   2> perform SCell release as specified in 5.3.5.5.8;
1> if the CellGroupConfig contains the spCellConfig:
   2> configure the SpCell as specified in 5.3.5.5.7;
1> if the CellGroupConfig contains the sCellToAddModList:
   2> perform SCell addition/modification as specified in 5.3.5.5.9;

5.3.5.5.2 Reconfiguration with sync

The UE shall perform the following actions to execute a reconfiguration with sync.
1> if the AS security is not activated, perform the actions upon going to RRC_IDLE as specified in 5.3.11 with the release cause ‘other’ upon which the procedure ends;
1> if no DAPS bearer is configured:
   2> stop timer T310 for the corresponding SpCell, if running;
1> if this procedure is executed for the MCG:
   2> if timer T316 is running;
      3> stop timer T316;
      3> clear the information included in VarRLF-Report, if any;
   2> resume MCG transmission, if suspended.
1> stop timer T312 for the corresponding SpCell, if running;
1> start timer T304 for the corresponding SpCell with the timer value set to t304, as included in the reconfigurationWithSync;
1> if the frequencyInfoDL is included:
   2> consider the target SpCell to be one on the SSB frequency indicated by the frequencyInfoDL with a physical cell identity indicated by the physCellId;
1> else:
   2> consider the target SpCell to be one on the SSB frequency of the source SpCell with a physical cell identity indicated by the physCellId;
1> start synchronising to the DL of the target SpCell;
1> apply the specified BCCH configuration defined in 9.1.1.1 for the target SpCell;
1> acquire the MIB of the target SpCell, which is scheduled as specified in TS 38.213 [13];
NOTE 1: The UE should perform the reconfiguration with sync as soon as possible following the reception of the RRC message triggering the reconfiguration with sync, which could be before confirming successful reception (HARQ and ARQ) of this message.
NOTE 2: The UE may omit reading the MIB if the UE already has the required timing information, or the timing information is not needed for random access.
   2> reset the MAC entity of this cell group;
   2> consider the SCell(s) of this cell group, if configured, that are not included in the SCellToAddModList in the RRCReconfiguration message, to be in deactivated state;
   2> apply the value of the newUE-Identity as the C-RNTI for this cell group;
   2> configure lower layers in accordance with the received spCellConfigCommon;
   2> configure lower layers in accordance with any additional fields, not covered in the previous, if included in the received reconfigurationWithSync.

5.3.5.5.8 SCell Release

The UE shall:
1> if the release is triggered by reception of the sCellToReleaseList:
   2> for each sCellIndex value included in the sCellToReleaseList:
      3> if the current UE configuration includes an SCell with value sCellIndex:
         4> release the SCell.

5.3.5.5.9 SCell Addition/Modification

The UE shall:
1> for each sCellIndex value included in the sCellToAddModList that is not part of the current UE configuration (SCell addition):
   2> add the SCell, corresponding to the sCellIndex, in accordance with the sCellConfigCommon and sCellConfigDedicated;
   2> if the sCellState is included:
      3> configure lower layers to consider the SCell to be in activated state;
   2> else:
      3> configure lower layers to consider the SCell to be in deactivated state;
   2> for each measId included in the measIdList within VarMeasConfig:
      3> if SCells are not applicable for the associated measurement; and
      3> if the concerned SCell is included in cellsTriggeredList defined within the VarMeasReportList for this measId:
         4> remove the concerned SCell from cellsTriggeredList defined within the VarMeasReportList for this measId;
1> for each sCellIndex value included in the sCellToAddModList that is part of the current UE configuration (SCell modification):
   2> modify the SCell configuration in accordance with the sCellConfigDedicated;
   2> if the sCellToAddModList was received in an RRCReconfiguration message including reconfigurationWithSync, or received in an RRCResume message, or received in an RRCReconfiguration message including reconfigurationWithSync embedded in an RRCResume message or embedded in an RRCReconfiguration message or embedded in an E-UTRA RRCConnectionReconfiguration message or embedded in an E-UTRA RRCConnectionResume message:
      3> if the sCellState is included:
         4> configure lower layers to consider the SCell to be in activated state;
      3> else:
         4> configure lower layers to consider the SCell to be in deactivated state.

5.3.5.8.3 T304 Expiry (Reconfiguration with Sync Failure)

The UE shall:
1> if T304 of the MCG expires:
   2> release dedicated preambles provided in rach-ConfigDedicated if configured;
   2> release dedicated msgA PUSCH resources provided in rach-ConfigDedicated if configured;
   2> if any DAPS bearer is configured, and radio link failure is not detected in the source PCell, according to subclause 5.3.10.3:
      3> reset MAC for the target PCell and release the MAC configuration for the target PCell;
      3> for each DAPS bearer:
         4> release the RLC entity or entities as specified in TS 38.322 [4], clause 5.1.3, and the associated logical channel for the target PCell;
         4> reconfigure the PDCP entity to release DAPS as specified in TS 38.323 [5];
      3> for each SRB:
         4> if the masterKeyUpdate was not received:
         5> configure the PDCP entity for the source PCell with state variables continuation as specified in TS 38.323 [5];
         4> release the PDCP entity for the target PCell;
         4> release the RLC entity as specified in TS 38.322 [4], clause 5.1.3, and the associated logical channel for the target PCell;
         4> trigger the PDCP entity for the source PCell to perform SDU discard as specified in TS 38.323 [5];
         4> re-establish the RLC entity for the source PCell;
      3> release the physical channel configuration for the target PCell;
      3> discard the keys used in target PCell (the K_{gNB} key, the K_{RRCenc} key, the K_{RRCint} key, the K_{UPint} key and the K_{UPenc} key), if any;
      3> resume suspended SRBs in the source PCell;
      3> for each non-DAPS bearer:
         4> revert back to the UE configuration used for the DRB in the source PCell, includes PDCP, RLC states variables, the security configuration and the data stored in transmission and reception buffers in PDCP and RLC entities;
      3> revert back to the UE measurement configuration used in the source PCell;
      3> initiate the failure information procedure as specified in subclause 5.7.5 to report DAPS handover failure.
   2> else:
      3> revert back to the UE configuration used in the source PCell;
      3> store the handover failure information in VarRLF-Report as described in the subclause 5.3.10.5;
      3> initiate the connection re-establishment procedure as specified in subclause 5.3.7.

5.3.7 RRC Connection Re-Establishment

5.3.7.1 General

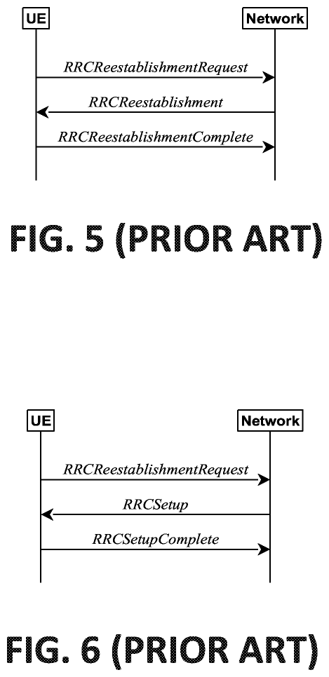

FIG. 5 is a reproduction of FIG. 5.3.7.1-1: RRC connection re-establishment, successful, from 3GPP specification 38.331 v16.7.0.

FIG. 6 is a reproduction of FIG. 5.3.7.1-2: RRC re-establishment, fallback to RRC establishment, successful, from 3GPP specification 38.331 v16.7.0.

The purpose of this procedure is to re-establish the RRC connection. A UE in RRC_CONNECTED, for which AS security has been activated with SRB2 and at least one DRB setup or, for IAB, SRB2, may initiate the procedure in order to continue the RRC connection. The connection re-establishment succeeds if the network is able to find and verify a valid UE context or, if the UE context cannot be retrieved, and the network responds with an RRCSetup according to clause 5.3.3.4.

The network applies the procedure e.g as follows:
When AS security has been activated and the network retrieves or verifies the UE context:
   to re-activate AS security without changing algorithms;
   to re-establish and resume the SRB1;
When UE is re-establishing an RRC connection, and the network is not able to retrieve or verify the UE context:
   to discard the stored AS Context and release all RBs and BH RLC channels;
   to fallback to establish a new RRC connection.

If AS security has not been activated, the UE shall not initiate the procedure but instead moves to RRC_IDLE directly, with release cause ‘other’. If AS security has been activated, but SRB2 and at least one DRB or, for IAB, SRB2, are not setup, the UE does not initiate the procedure but instead moves to RRC_IDLE directly, with release cause ‘RRC connection failure’.

5.3.7.2 Initiation

The UE initiates the procedure when one of the following conditions is met:
1> upon detecting radio link failure of the MCG and t316 is not configured, in accordance with 5.3.10; or
1> upon detecting radio link failure of the MCG while SCG transmission is suspended, in accordance with 5.3.10; or
1> upon detecting radio link failure of the MCG while PSCell change or PSCell addition is ongoing, in accordance with 5.3.10; or
1> upon re-configuration with sync failure of the MCG, in accordance with sub-clause 5.3.5.8.3; or
1> upon mobility from NR failure, in accordance with sub-clause 5.4.3.5; or
1> upon integrity check failure indication from lower layers concerning SRB1 or SRB2, except if the integrity check failure is detected on the RRCReestablishment message; or
1> upon an RRC connection reconfiguration failure, in accordance with sub-clause 5.3.5.8.2; or
1> upon detecting radio link failure for the SCG while MCG transmission is suspended, in accordance with subclause 5.3.10.3 in N_{R}-DC or in accordance with TS 36.331 [10] subclause 5.3.11.3 in NE-DC; or
1> upon reconfiguration with sync failure of the SCG while MCG transmission is suspended in accordance with subclause 5.3.5.8.3; or
1> upon SCG change failure while MCG transmission is suspended in accordance with TS 36.331 [10] subclause 5.3.5.7a; or
1> upon SCG configuration failure while MCG transmission is suspended in accordance with subclause 5.3.5.8.2 in N_{R}-DC or in accordance with TS 36.331 [10] subclause 5.3.5.5 in NE-DC; or
1> upon integrity check failure indication from SCG lower layers concerning SRB3 while MCG is suspended; or
1> upon T316 expiry, in accordance with sub-clause 5.7.3b.5.

Upon initiation of the procedure, the UE shall:
1> stop timer T310, if running;
1> stop timer T312, if running;
1> stop timer T304, if running;
1> start timer T311;
1> stop timer T316, if running;
1> if UE is not configured with conditionalReconfiguration:
   2> reset MAC;
   2> release spCellConfig, if configured;
   2> suspend all RBs, and BH RLC channels for IAB-MT, except SRB0;
   2> release the MCG SCell(s), if configured;
   2> if MR-DC is configured:
      3> perform MR-DC release, as specified in clause 5.3.5.10; 2> release delayBudgetReportingConfig, if configured and stop timer T342, if running;
   2> release overheatingAssistanceConfig, if configured and stop timer T345, if running;
   2> release idc-AssistanceConfig, if configured;
   2> release btNameList, if configured;
   2> release wlanNameList, if configured;
   2> release sensorNameList, if configured;
   2> release drx-PreferenceConfig for the MCG, if configured and stop timer T346a associated with the MCG, if running;
   2> release maxBW-PreferenceConfig for the MCG, if configured and stop timer T346b associated with the MCG, if running;
   2> release maxCC-PreferenceConfig for the MCG, if configured and stop timer T346c associated with the MCG, if running;
   2> release maxMIMO-LayerPreferenceConfig for the MCG, if configured and stop timer T346d associated with the MCG, if running;
2> release minSchedulingOffsetPreferenceConfig for the MCG, if configured stop timer T346e associated with the MCG, if running;
   2> release releasePreferenceConfig, if configured stop timer T346f, if running;
   2> release onDemandSIB-Request if configured, and stop timer T350, if running;
   2> release referenceTimePreferenceReporting, if configured;
   2> release sl-AssistanceConfig N_{R}, if configured;
   2> release obtainCommonLocation, if configured;
1> perform cell selection in accordance with the cell selection process as specified in TS 38.304 [20].

In 38.331([2] 3GPP specification 38.331 v16.7.0), Cell group and Serving Cell configuration is introduced, including TAG configuration:

CellGroupConfig

The CellGroupConfig IE is used to configure a master cell group (MCG) or secondary cell group (SCG). A cell group comprises of one MAC entity, a set of logical channels with associated RLC entities and of a primary cell (SpCell) and one or more secondary cells (SCells).

CellGroupConfig information element

| | |
|---|---|
| -- Configuration of one Cell-Group: | |
| CellGroupConfig : : = | SEQUENCE { |
| cellGroupId | CellGroupId, |
| rlc-BearerToAddModList | SEQUENCE (SIZE(1..maxLC-ID)) OF RLC-BearerConfig |
| OPTIONAL, Need N | |
| rlc-BearerToReleaseList | SEQUENCE (SIZE(1..maxLC-ID)) OF LogicalChannelIdentity |
| OPTIONAL, -- Need N | |
| mac-CellGroupConfig | MAC-CellGroupConfig |
| OPTIONAL, -- Need M | |
| physicalCellGroupConfig | PhysicalCellGroupConfig |
| OPTIONAL, -- Need M | |
| spCellConfig | SpCellConfig |
| OPTIONAL, -- Need M | |
| sCellToAddModList | SEQUENCE (SIZE (1..maxNrofSCells)) OF SCellConfig |
| OPTIONAL, -- Need N | |
| sCellToReleaseList | SEQUENCE (SIZE (1..maxNrofSCells) ) OF SCellIndex |
| OPTIONAL, -- Need N | |
| ..., | |
| } | |

-- Serving cell specific MAC and PHY parameters for a SpCell:

| | |
|---|---|
| SpCellConfig : := | SEQUENCE { |
| servCellIndex | ServCellIndex |
| OPTIONAL, -- Cond SCG | |
| reconfigurationWithSync | ReconfigurationWithSync |
| OPTIONAL, -- Cond ReconfWithSync | |
| rlf-TimersAndConstants | SetupRelease { RLF-TimersAndConstants } |
| OPTIONAL, --Need M | |
| rlmInSyncOutOf SyncThreshold | ENUMERATED {n1 } |
| OPTIONAL, --Need S | |
| spCellConfigDedicated | ServingCellConfig |
| OPTIONAL, --Need M | |
| ... | |
| } | |
| ReconfigurationWithSync : : = | SEQUENCE { |
| spCellConfigCommon | ServingCellConfigCommon |
| OPTIONAL, --Need M | |
| newUE-Identity | RNTI-Value, |
| t304 | ENUMERATED {ms50, ms100, ms150, ms200, ms500, ms1000, ms2000, |
| ms10000}, | |
| rach-ConfigDedicated | CHOICE { |
| uplink | RACH-ConfigDedicated, |
| supplementaryUplink | RACH-ConfigDedicated |
| } | |
| OPTIONAL, -- Need N | |
| ..., | |
| } | |
| SCellConfig : : = | SEQUENCE { |
| sCellIndex | SCellIndex, |
| sCellConfigCommon | ServingCellConfigCommon |
| OPTIONAL, -- Cond SCellAdd | |
| sCellConfigDedicated | ServingCellConfig |
| OPTIONAL, -- Cond SCellAddMod | |
| ..., | |
| [[ | |
| smtc | SSB-MTC |
| OPTIONAL -- Need S | |
| ]], | |
| [[ | |
| sCellState-r16 | ENUMERATED {activated} |
| OPTIONAL, -- Cond SCellAddSync | |
| secondaryDRX-GroupConfig-r16 | ENUMERATED {true } |
| OPTIONAL -- Cond DRX-Config2 | |
| ]]} | |

CellGroupConfig field descriptions

sCellState
Indicates whether the SCell shall be considered to be in activated state
upon SCell configuration.
sCellToAddModList
List of secondary serving cells (SCells) to be added or modified.
sCellToReleaseList
List of secondary serving cells (SCells) to be released.
secondaryDRX-GroupConfig
The field is used to indicate whether the SCell belongs to the
secondary DRX group. All serving cells in the secondary DRX
group shall belong to one Frequency Range and all serving cells in
the legacy DRX group shall belong to another Frequency Range.
spCellConfig
Parameters for the SpCell of this cell group (PCell of MCG or PSCell of
SCG).

ReconfigurationWithSync field descriptions

rach-ConfigDedicated
Random access configuration to be used for the reconfiguration with sync
(e.g. handover). The UE performs the RA according to these parameters
in the firstActiveUplinkBWP (see UplinkConfig).

SCellConfig field descriptions

smtc
The SSB periodicity/offset/duration configuration of target cell for NR
SCell addition. The network sets the periodicityAndOffset to indicate
the same periodicity as ssb-periodicityServingCell in
sCellConfigCommon. The smtc is based on the timing of the SpCell of
associated cell group. In case of inter-RAT handover to NR, the timing
reference is the NR PCell. In case of intra-NR PCell change (standalone
NR) or NR PSCell change (EN-DC), the timing reference is the target
SpCell. If the field is absent, the UE uses the SMTC in the measObjectNR
having the same SSB frequency and subcarrier spacing, as configured
before the reception of the RRC message.

SpCellConfig field descriptions

reconfigurationWithSync
Parameters for the synchronous reconfiguration to the target SpCell.
rlf-TimersAndConstants
Timers and constants for detecting and triggering cell-level radio link
failure. For the SCG, rlf-TimersAndConstants can only be set to setup
and is always included at SCG addition.
servCellIndex
Serving cell ID of a PSCell. The PCell of the Master Cell Group uses
ID = 0.

| Conditional Presence | Explanation |
|---|---|
| ReconfWithSync | The field is mandatory present in the RRCReconfiguration message: |
| | in each configured CellGroupConfig for which the SpCell changes, |
| | in the masterCellGroup: |
| | at change of AS security key derived from K_{gNB}, |
| | in an RRCReconfiguration message contained in a |
| | DLInformationTransferMRDC message, |
| | in the secondaryCellGroup at: |
| | PSCell addition, |
| | SCG resume with NR-DC or (NG)EN-DC, |
| | update of required SI for PSCell, |
| | change of AS security key derived from S-K_{gNB} in NR-DC while the UE is |
| | configured with at least one radio bearer with keyToUse set to secondary |
| | and that is not released by this RRCReconfiguration message, |
| | MN handover in (NG)EN-DC. |
| | Otherwise, it is optionally present, need M. The field is absent in the |
| | masterCellGroup in RRCResume and RRCSetup messages and is absent in the |
| | masterCellGroup in RRCReconfiguration messages if source configuration is not |
| | released during DAPS handover. |
| SCellAdd | The field is mandatory present upon SCell addition; otherwise it is absent, Need M. |
| SCellAddMod | The field is mandatory present upon SCell addition; otherwise it is optionally present, |
| | need M. |
| SCellAddSync | The field is optionally present, Need N, in case of SCell addition, reconfiguration with |
| | sync, and resuming an RRC connection. It is absent otherwise. |
| SCG | The field is mandatory present in an SpCellConfig for the PSCell. It is absent |
| | otherwise. |

CellGroupId

The IE CellGroupId is used to identify a cell group. Value 0 identifies the master cell group. Other values identify secondary cell groups. In this version of the specification only values 0 and 1 are supported.

### CellGroupId Information Element

CellGroupId::=INTEGER (0 . . . maxSecondaryCellGroups)

CellIdentity

The IE CellIdentity is used to unambiguously identify a cell within a PLMN/SNPN.

### CellIdentity Information Element

CellIdentity::=BIT STRING (SIZE (36))

ServCellIndex

The IE ServCellIndex concerns a short identity, used to uniquely identify a serving cell (i.e. the PCell, the PSCell or an SCell) across the cell groups. Value 0 applies for the PCell, while the SCellIndex that has previously been assigned applies for SCells.

### ServCellIndex Information Element

ServCellIndex::=INTEGER (0 . . . maxNrofServingCells-1)

ServingCellConfig

The IE ServingCellConfig is used to configure (add or modify) the UE with a serving cell, which may be the SpCell or an SCell of an MCG or SCG. The parameters herein are mostly UE specific but partly also cell specific (e.g. in additionally configured bandwidth parts). Reconfiguration between a PUCCH and PUCCHless SCell is only supported using an SCell release and add.

| | |
|---|---|
| ServingCellConfig : := | SEQUENCE { |
| tdd-UL-DL-ConfigurationDedicated | TDD-UL-DL-ConfigDedicated |
| OPTIONAL, -- Cond TDD | |
| initialDownlinkBWP | BWP-DownlinkDedicated |
| OPTIONAL, -- Need M | |
| downlinkBWP-ToReleaseList | SEQUENCE (SIZE (1 .. maxNrofBWPs) ) OF BWP-Id |
| OPTIONAL, -- Need N | |
| downlinkBWP-ToAddModList | SEQUENCE (SIZE (1 .. maxNrofBWPs) ) OF BWP-Downlink |
| OPTIONAL, -- Need N | |
| firstActiveDownlinkBWP-Id | BWP-Id |
| OPTIONAL, -- Cond SyncAndCellAdd | |
| bwp-InactivityTimer | ENUMERATED {ms2, ms3, ms4, ms5, ms6, ms8, ms10, ms20, ms30, |
| | ms40, ms50, ms60, ms80,ms100, ms200,ms300, ms500, |
| | ms 750, ms1280, ms1920, ms2560, spare10, spare9, |
| spare8, | |
| | spare7, spare6, spare5, spare4, spare3, spare2, |
| spare1 } OPTIONAL, -- Need R | |
| defaultDownlinkBWP-Id | BWP-Id |
| OPTIONAL, -- Need S | |
| uplinkConfig | UplinkConfig |
| OPTIONAL, -- Need M | |
| supplementaryUplink | UplinkConfig |
| OPTIONAL, -- Need M | |
| pdcch-ServingCellConfig | SetupRelease { PDCCH-ServingCellConfig } |
| OPTIONAL, -- Need M | |
| pdsch-ServingCellConfig | SetupRelease { PDSCH-ServingCellConfig } |
| OPTIONAL, -- Need M | |
| csi-MeasConfig | SetupRelease { CSI-MeasConfig } |
| OPTIONAL, -- Need M | |
| sCellDeactivationTimer | ENUMERATED {ms20, ms40, ms80, ms160, ms200, ms240, |
| | ms320, ms400, ms480, ms520, ms640, ms720, |
| | ms840, ms1280, spare2, spare1} OPTIONAL, - |
| - Cond ServingCellWithoutPUCCH | |
| crossCarrierSchedulingConfig | CrossCarrierSchedulingConfig |
| OPTIONAL, -- Need M | |
| tag-Id | TAG-Id, |
| pathlossReferenceLinking | ENUMERATED {spCell, sCell} |
| OPTIONAL, -- Cond SCellOnly | |
| servingCellMO | MeasObjectId |
| OPTIONAL, -- Cond MeasObject | |
| ..., | |
| } | |
| UplinkConfig : := | SEQUENCE { |
| initialUplinkBWP | BWP-UplinkDedicated |
| OPTIONAL, -- Need M | |
| uplinkBWP-ToReleaseList | SEQUENCE (SIZE (1..maxNrofBWPs) ) OF BWP-Id |
| OPTIONAL, -- Need N | |
| uplinkBWP-ToAddModList | SEQUENCE (SIZE (1..maxNrofBWPs) ) OF BWP-Uplink |
| OPTIONAL, -- Need N | |
| firstActiveUplinkBWP-Id | BWP-Id |
| OPTIONAL, -- Cond SyncAndCellAdd | |
| pusch-ServingCellConfig | SetupRelease { PUSCH-ServingCellConfig } |
| OPTIONAL, -- Need M | |
| carrierSwitching | SetupRelease { SRS-CarrierSwitching } |
| OPTIONAL, -- Need M | |
| ..., | |
| } | |
| DormancyGroupID-r16 : := | INTEGER (0..4) |
| DormantBWP-Config-r16: : = | SEQUENCE { |
| dormantBWP-Id-r16 | BWP-Id |
| OPTIONAL, -- Need M | |
| withinActiveTimeConfig-r16 | SetupRelease { WithinActiveTimeConfig-r16 } |
| OPTIONAL, --Need M | |
| outsideActiveTimeConfig-r16 | SetupRelease { OutsideActiveTimeConfig-r16 } |
| OPTIONAL -- Need M | |
| } | |

ServingCellConfig field descriptions

bwp-InactivityTimer
The duration in ms after which the UE falls back to the default Bandwidth Part (see TS 38.321 [3], clause 5.15). When
the network releases the timer configuration, the UE stops the timer without switching to the default BWP.
defaultDownlinkBWP-Id
The initial bandwidth part is referred to by BWP-Id = 0. ID of the downlink bandwidth part to be used upon expiry of the
BWP inactivity timer. This field is UE specific. When the field is absent the UE uses the initial BWP as default BWP.
(see TS 38.213 [13], clause 12 and TS 38.321 [3], clause 5.15).
dormantBWP-Config
The dormant BWP configuration for an SCell. This field can be configured only for a (non-PUCCH) SCell.
downlinkBWP-ToAddModList
List of additional downlink bandwidth parts to be added or modified. (see TS 38.213 [13], clause 12).
downlinkBWP-ToReleaseList
List of additional downlink bandwidth parts to be released. (see TS 38.213 [13], clause 12).
firstActiveDownlinkBWP-Id
If configured for an SpCell, this field contains the ID of the DL BWP to be activated upon performing the RRC (re-
)configuration. If the field is absent, the RRC (re-)configuration does not impose a BWP switch.
If configured for an SCell, this field contains the ID of the downlink bandwidth part to be used upon activation of an
SCell. The initial bandwidth part is referred to by BWP-Id = 0.
Upon reconfiguration with reconfigurationWithSync, the network sets the firstActiveDownlinkBWP-Id and
firstActiveUplinkBWP-Id to the same value.
initialDownlinkBWP
The dedicated (UE-specific) configuration for the initial downlink bandwidth-part (i.e. DL BWP#0). If any of the optional
IEs are configured within this IE, the UE considers the BWP#0 to be an RRC configured BWP (from UE capability
viewpoint). Otherwise, the UE does not consider the BWP#0 as an RRC configured BWP (from UE capability
viewpoint). Network always configures the UE with a value for this field if no other BWPs are configured. NOTE1
pdsch-ServingCellConfig
PDSCH related parameters that are not BWP-specific.
sCellDeactivationTimer
SCell deactivation timer in TS 38.321 [3]. If the field is absent, the UE applies the value infinity.
servingCellMO
measObjectId of the MeasObjectNR in MeasConfig which is associated to the serving cell. For this MeasObjectNR, the
following relationship applies between this MeasObjectNR and frequencyInfoDL in ServingCellConfigCommon of the
serving cell: if ssbFrequency is configured, its value is the same as the absoluteFrequencySSB and if csi-rs-
ResourceConfigMobility is configured, the value of its subcarrierSpacing is present in one entry of the scs-
SpecificCarrierList, csi-RS-CellListMobility includes an entry corresponding to the serving cell (with cellId equal to
physCellId in ServingCellConfigCommon) and the frequency range indicated by the csi-rs-MeasurementBW of the entry
in csi-RS-CellListMobility is included in the frequency range indicated by in the entry of the scs-SpecificCarrierList.
supplementaryUplink
Network may configure this field only when supplementaryUplinkConfig is configured in ServingCellConfigCommon or
supplementaryUplink is configured in ServingCellConfigCommonSIB.
supplementaryUplinkRelease
If this field is included, the UE shall release the uplink configuration configured by supplementaryUplink. The network
only includes either supplementaryUplinkRelease or supplementaryUplink at a time.
tag-Id
Timing Advance Group ID, as specified in TS 38.321 [3], which this cell belongs to.
tdd-UL-DL-ConfigurationDedicated-IAB-MT
Resource configuration per IAB-MT D/U/F overrides all symbols (with a limitation that effectively only flexible symbols
can be overwritten in Rel-16) per slot over the number of slots as provided by TDD-UL-DL ConfigurationCommon.
uplinkConfig
Network may configure this field only when uplinkConfigCommon is configured in ServingCellConfigCommon or
ServingCellConfigCommonSIB. Addition or release of this field can only be done upon SCell addition or release
(respectively).

UplinkConfig field descriptions

firstActiveUplinkBWP-Id
If configured for an SpCell, this field contains the ID of the UL BWP to be activated upon performing the RRC (re-
)configuration. If the field is absent, the RRC (re-)configuration does not impose a BWP switch.
If configured for an SCell, this field contains the ID of the uplink bandwidth part to be used upon activation of an SCell.
The initial bandwidth part is referred to by BandiwdthPartId = 0.
initialUplinkBWP
The dedicated (UE-specific) configuration for the initial uplink bandwidth-part (i.e. UL BWP#0). If any of the optional IEs
are configured within this IE as part of the IE uplinkConfig, the UE considers the BWP#0 to be an RRC configured BWP
(from UE capability viewpoint). Otherwise, the UE does not consider the BWP#0 as an RRC configured BWP (from UE
capability viewpoint). Network always configures the UE with a value for this field if no other BWPs are configured.
NOTE1
pusch-ServingCellConfig
PUSCH related parameters that are not BWP-specific.
uplinkBWP-ToAddModList
The additional bandwidth parts for uplink to be added or modified. In case of TDD uplink- and downlink BWP with the
same bandwidthPartId are considered as a BWP pair and must have the same center frequency.
uplinkBWP-ToReleaseList
The additional bandwidth parts for uplink to be released.

TAG-Config

The IE TAG-Config is used to configure parameters for a time-alignment group.

TAG-Config information element

| | |
|---|---|
| TAG-Config : := | SEQUENCE { |
| tag-ToReleaseList | SEQUENCE (SIZE (1..maxNrofTAGs) ) OF TAG-Id |
| OPTIONAL, -- Need N | |
| tag-ToAddModList | SEQUENCE (SIZE (1..maxNrofTAGs) ) OF TAG |
| OPTIONAL -- Need N | |
| } | |
| TAG : := | SEQUENCE { |
| tag-Id | TAG-Id, |
| timeAlignmentTimer | TimeAlignmentTimer, |
| ... | |
| } | |
| TAG-Id : := | INTEGER (0 .. maxNrofTAGs-1) |
| TimeAlignmentTimer : := | ENUMERATED {ms500, ms750, ms1280, ms1920, ms2560, ms5120, |
| ms10240, infinity} | |

TAG field descriptions

tag-Id
Indicates the TAG of the SpCell or an SCell, see TS 38.321 [3]. Uniquely
identifies the TAG within the scope of a Cell Group (i.e. MCG or SCG).
timeAlignmentTimer
Value in ms of the timeAlignmentTimer for TAG with ID tag-Id, as
specified in TS 38.321 [3].

TCI-State

The IE TCI-State associates one or two DL reference signals with a corresponding quasi-colocation (QCL) type.

TCI-State information element

| | |
|---|---|
| TCI-State ::= | SEQUENCE { |
| tci-StateId | TCI-StateId, |
| qcl-Type1 | QCL-Info, |
| qcl-Type2 | QCL-Info |
| OPTIONAL, -- Need R | |
| ... | |
| } | |
| QCL-Info ::= | SEQUENCE { |
| cell | ServCellIndex |
| OPTIONAL, -- Need R | |
| bwp-Id | BWP-Id |
| OPTIONAL, -- Cond CSI-RS-Indicated | |
| referenceSignal | CHOICE { |
| csi-rs | NZP-CSI-RS-ResourceId, |
| ssb | SSB-Index |
| }, | |
| qcl-Type | ENUMERATED {typeA, typeB, typeC, typeD} , |
| ... | |
| } | |

QCL-Info field descriptions

bwp-Id
The DL BWP which the RS is located in.
cell
The UE's serving cell in which the referenceSignal is configured. If the
field is absent, it applies to the serving cell in which the TCI-State is
configured. The RS can be located on a serving cell other than the serving
cell in which the TCI-State is configured only if the qcl-Type is
configured as typeC or typeD. See TS 38.214 [19] clause 5.1.5.
referenceSignal
Reference signal with which quasi-collocation information is provided as
specified in TS 38.214 [19] subclause 5.1.5.
qcl-Type
QCL type as specified in TS 38.214 [19] subclause 5.1.5.

TCI-StateId

The IE TCI-StateId is used to identify one TCI-State configuration.

TCI-StateId Information Element

TCI-StateId::=INTEGER (0 . . . maxNrofTCI-States-1)

In 3GPP specification 38.321 ([3] 3GPP specification 38.321 v16.7.0), random access procedure and timing advance/time alignment is introduced:

Timing Advance Group: A group of Serving Cells that is configured by RRC and that, for the cells with a UL configured, using the same timing reference cell and the same Timing Advance value. A Timing Advance Group containing the SpCell of a MAC entity is referred to as Primary Timing Advance Group (PTAG), whereas the term Secondary Timing Advance Group (STAG) refers to other TAGs.

5.1 Random Access Procedure

5.1.1 Random Access Procedure Initialization

The Random Access procedure described in this clause is initiated by a PDCCH order, by the MAC entity itself, or by RRC for the events in accordance with TS 38.300 [2]. There is only one Random Access procedure ongoing at any point in time in a MAC entity. The Random Access procedure on an SCell shall only be initiated by a PDCCH order with ra-PreambleIndex different from 0b000000.

RRC configures the following parameters for the Random Access procedure:
prach-ConfigurationIndex: the available set of PRACH occasions for the transmission of the Random Access Preamble for Msg1. These are also applicable to the MSGA PRACH if the PRACH occasions are shared between 2-step and 4-step RA types;
prach-ConfigurationPeriodScaling-IAB: the scaling factor defined in TS 38.211 [8] and applicable to IAB-MTs, extending the periodicity of the PRACH occasions baseline configuration indicated by prach-ConfigurationIndex;
prach-ConfigurationFrameOffset-IAB: the frame offset defined in TS 38.211 [8] and applicable to IAB-MTs, altering the ROs frame defined in the baseline configuration indicated by prach-ConfigurationIndex;
prach-ConfigurationSOffset-IAB: the subframe/slot offset defined in TS 38.211 [8] and applicable to IAB-MTs, altering the ROs subframe or slot defined in the baseline configuration indicated by prach-ConfigurationIndex;
msgA-PRACH-ConfigurationIndex: the available set of PRACH occasions for the transmission of the Random Access Preamble for MSGA in 2-step RA type;
preambleReceivedTargetPower: initial Random Access Preamble power for 4-step RA type;
msgA-PreambleReceivedTargetPower: initial Random Access Preamble power for 2-step RA type;
rsrp-ThresholdSSB: an RSRP threshold for the selection of the SSB for 4-step RA type. If the Random Access procedure is initiated for beam failure recovery, rsrp-ThresholdSSB used for the selection of the SSB within candidateBeamRSList refers to rsrp-ThresholdSSB in BeamFailureRecoveryConfig IE;
rsrp-ThresholdCSI-RS: an RSRP threshold for the selection of CSI-RS for 4-step RA type. If the Random Access procedure is initiated for beam failure recovery, rsrp-ThresholdCSI-RS is equal to rsrp-ThresholdSSB in BeamFailureRecoveryConfig IE;
msgA-RSRP-ThresholdSSB: an RSRP threshold for the selection of the SSB for 2-step RA type;
rsrp-ThresholdSSB-SUL: an RSRP threshold for the selection between the NUL carrier and the SUL carrier;
msgA-RSRP-Threshold: an RSRP threshold for selection between 2-step RA type and 4-step RA type when both 2-step and 4-step RA type Random Access Resources are configured in the UL BWP;
msgA-TransMax: The maximum number of MSGA transmissions when both 4-step and 2-step RA type Random Access Resources are configured;
candidateBeamRSList: a list of reference signals (CSI-RS and/or SSB) identifying the candidate beams for recovery and the associated Random Access parameters;
recoverySearchSpaceld: the search space identity for monitoring the response of the beam failure recovery request;
the set of Random Access Preambles and/or PRACH occasions for beam failure recovery request, if any;
the set of Random Access Preambles and/or PRACH occasions for reconfiguration with sync, if any;

When the Random Access procedure is initiated on a Serving Cell, the MAC entity shall:
1> flush the Msg3 buffer;
1> flush the MSGA buffer;
1> set the PREAMBLE_TRANSMISSION_COUNTER to 1;
1> set the PREAMBLE_POWER_RAMPING_COUNTER to 1;
1> set the PREAMBLE_BACKOFF to 0 ms;
1> set POWER_OFFSET_2STEP_RA to 0 dB;
1> if the carrier to use for the Random Access procedure is explicitly signalled:
   2> select the signalled carrier for performing Random Access procedure;
   2> set the PCMAX to P_{CMAX,fc} of the signalled carrier.
1> else if the carrier to use for the Random Access procedure is not explicitly signalled; and
1> if the Serving Cell for the Random Access procedure is configured with supplementary uplink as specified in TS 38.331 [5]; and
1> if the RSRP of the downlink pathloss reference is less than rsrp-ThresholdSSB-SUL:
   2> select the SUL carrier for performing Random Access procedure;
   2> set the PCMAX to P_{CMAX,fc} of the SUL carrier.
1> else:
   2> select the NUL carrier for performing Random Access procedure;
   2> set the PCMAX to P_{CMAX,fc} of the NUL carrier.
1> perform the BWP operation as specified in clause 5.15;
1> if the Random Access procedure is initiated by PDCCH order and if the ra-PreambleIndex explicitly provided by PDCCH is not 0b000000; or
1> if the Random Access procedure was initiated for SI request (as specified in TS 38.331 [5]) and the Random Access Resources for SI request have been explicitly provided by RRC; or
1> if the Random Access procedure was initiated for SpCell beam failure recovery (as specified in clause 5.17) and if the contention-free Random Access Resources for beam failure recovery request for 4-step RA type have been explicitly provided by RRC for the BWP selected for Random Access procedure; or
1> if the Random Access procedure was initiated for reconfiguration with sync and if the contention-free Random Access Resources for 4-step RA type have been explicitly provided in rach-ConfigDedicated for the BWP selected for Random Access procedure:
   2> set the RA_TYPE to 4-stepRA.
1> else if the BWP selected for Random Access procedure is configured with both 2-step and 4-step RA type Random Access Resources and the RSRP of the downlink pathloss reference is above msgA-RSRP-Threshold; or
1> if the BWP selected for Random Access procedure is only configured with 2-step RA type Random Access resources (i.e. no 4-step RACH RA type resources configured); or
1> if the Random Access procedure was initiated for reconfiguration with sync and if the contention-free Random Access Resources for 2-step RA type have been explicitly provided in rach-ConfigDedicated for the BWP selected for Random Access procedure:
   2> set the RA_TYPE to 2-stepRA.
1> else:
   2> set the RA_TYPE to 4-stepRA.
1> perform initialization of variables specific to Random Access type as specified in clause 5.1.1a;
1> if RA_TYPE is set to 2-stepRA:
   2> perform the Random Access Resource selection procedure for 2-step RA type (see clause 5.1.2a).
1> else:
   2> perform the Random Access Resource selection procedure (see clause 5.1.2).

5.1.2 Random Access Resource Selection

If the selected RA_TYPE is set to 4-stepRA, the MAC entity shall:
1> if the Random Access procedure was initiated for SpCell beam failure recovery (as specified in clause 5.17); and
1> if the beamFailureRecoveryTimer (in clause 5.17) is either running or not configured; and
1> if the contention-free Random Access Resources for beam failure recovery request associated with any of the SSBs and/or CSI-RSs have been explicitly provided by RRC; and
1> if at least one of the SSBs with SS-RSRP above rsrp-ThresholdSSB amongst the SSBs in candidateBeamRSList or the CSI-RSs with CSI-RSRP above rsrp-ThresholdCSI-RS amongst the CSI-RSs in candidateBeamRSList is available:
   2> select an SSB with SS-RSRP above rsrp-ThresholdSSB amongst the SSBs in candidateBeamRSList or a CSI-RS with CSI-RSRP above rsrp-ThresholdCSI-RS amongst the CSI-RSs in candidateBeamRSList;
   2> if CSI-RS is selected, and there is no ra-PreambleIndex associated with the selected CSI-RS:
      3> set the PREAMBLE_INDEX to a ra-PreambleIndex corresponding to the SSB in candidateBeamRSList which is quasi-colocated with the selected CSI-RS as specified in TS 38.214 [7].
   2> else:
      3> set the PREAMBLE_INDEX to a ra-PreambleIndex corresponding to the selected SSB or CSI-RS from the set of Random Access Preambles for beam failure recovery request.
1> else if the ra-PreambleIndex has been explicitly provided by PDCCH; and
1> if the ra-PreambleIndex is not 0b000000:
   2> set the PREAMBLE_INDEX to the signalled ra-PreambleIndex;
   2> select the SSB signalled by PDCCH.
1> else if the contention-free Random Access Resources associated with SSBs have been explicitly provided in rach-ConfigDedicated and at least one SSB with SS-RSRP above rsrp-ThresholdSSB amongst the associated SSBs is available:
   2> select an SSB with SS-RSRP above rsrp-ThresholdSSB amongst the associated SSBs;
   2> set the PREAMBLE_INDEX to a ra-PreambleIndex corresponding to the selected SSB.
1> else if the contention-free Random Access Resources associated with CSI-RSs have been explicitly provided in rach-ConfigDedicated and at least one CSI-RS with CSI-RSRP above rsrp-ThresholdCSI-RS amongst the associated CSI-RSs is available:
   2> select a CSI-RS with CSI-RSRP above rsrp-ThresholdCSI-RS amongst the associated CSI-RSs;
   2> set the PREAMBLE_INDEX to a ra-PreambleIndex corresponding to the selected CSI-RS.
1> else if the Random Access procedure was initiated for SI request (as specified in TS 38.331 [5]); and
1> if the Random Access Resources for SI request have been explicitly provided by RRC:
   2> if at least one of the SSBs with SS-RSRP above rsrp-ThresholdSSB is available:
      3> select an SSB with SS-RSRP above rsrp-ThresholdSSB.
   2> else:
      3> select any SSB.
   2> select a Random Access Preamble corresponding to the selected SSB, from the Random Access Preamble(s) determined according to ra-PreambleStartIndex as specified in TS 38.331 [5];
   2> set the PREAMBLE_INDEX to selected Random Access Preamble.
1> else (i.e. for the contention-based Random Access preamble selection):
   2> if at least one of the SSBs with SS-RSRP above rsrp-ThresholdSSB is available:
      3> select an SSB with SS-RSRP above rsrp-ThresholdSSB.
   2> else:
      3> select any SSB.
   2> select a Random Access Preamble randomly with equal probability from the Random Access Preambles associated with the selected SSB and the selected Random Access Preambles group;
   2> set the PREAMBLE_INDEX to the selected Random Access Preamble.
1> if the Random Access procedure was initiated for SI request (as specified in TS 38.331 [5]); and
1> if ra-AssociationPeriodIndex and si-RequestPeriod are configured:
   2> determine the next available PRACH occasion from the PRACH occasions corresponding to the selected SSB in the association period given by ra-AssociationPeriodIndex in the si-RequestPeriod permitted by the restrictions given by the ra-ssb-OccasionMaskIndex if configured (the MAC entity shall select a PRACH occasion randomly with equal probability amongst the consecutive PRACH occasions according to clause 8.1 of TS 38.213 [6] corresponding to the selected SSB).
1> else if an SSB is selected above:
   2> determine the next available PRACH occasion from the PRACH occasions corresponding to the selected SSB permitted by the restrictions given by the ra-ssb-OccasionMaskIndex if configured or indicated by PDCCH (the MAC entity shall select a PRACH occasion randomly with equal probability amongst the consecutive PRACH occasions according to clause 8.1 of TS 38.213 [6], corresponding to the selected SSB; the MAC entity may take into account the possible occurrence of measurement gaps when determining the next available PRACH occasion corresponding to the selected SSB).
1> else if a CSI-RS is selected above:
   2> if there is no contention-free Random Access Resource associated with the selected CSI-RS:
      3> determine the next available PRACH occasion from the PRACH occasions, permitted by the restrictions given by the ra-ssb-OccasionMaskIndex if configured, corresponding to the SSB in candidateBeamRSList which is quasi-colocated with the selected CSI-RS as specified in TS 38.214 [7] (the MAC entity shall select a PRACH occasion randomly with equal probability amongst the consecutive PRACH occasions according to clause 8.1 of TS 38.213 [6], corresponding to the SSB which is quasi-colocated with the selected CSI-RS; the MAC entity may take into account the possible occurrence of measurement gaps when determining the next available PRACH occasion corresponding to the SSB which is quasi-colocated with the selected CSI-RS).
   2> else:
      3> determine the next available PRACH occasion from the PRACH occasions in ra-OccasionList corresponding to the selected CSI-RS (the MAC entity shall select a PRACH occasion randomly with equal probability amongst the PRACH occasions occurring simultaneously but on different subcarriers, corresponding to the selected CSI-RS; the MAC entity may take into account the possible occurrence of measurement gaps when determining the next available PRACH occasion corresponding to the selected CSI-RS).
1> perform the Random Access Preamble transmission procedure (see clause 5.1.3).

5.1.3 Random Access Preamble Transmission

The MAC entity shall, for each Random Access Preamble:
1> if PREAMBLE_TRANSMISSION_COUNTER is greater than one; and
1> if the notification of suspending power ramping counter has not been received from lower layers; and
1> if LBT failure indication was not received from lower layers for the last Random Access Preamble transmission; and
1> if SSB or CSI-RS selected is not changed from the selection in the last Random Access Preamble transmission:
   2> increment PREAMBLE_POWER_RAMPING_COUNTER by 1.
1> select the value of DELTA_PREAMBLE according to clause 7.3;
1> set PREAMBLE_RECEIVED_TARGET_POWER to preambleReceivedTargetPower+DELTA_PREAMBLE+(PREAMBLE_POWER_RAMPING_COUNTER−1)×PREAMBLE_POWER_RAMPING_STEP+POWER_OFFSET_2STEP_RA;
1> except for contention-free Random Access Preamble for beam failure recovery request, compute the RA-RNTI associated with the PRACH occasion in which the Random Access Preamble is transmitted;
1> instruct the physical layer to transmit the Random Access Preamble using the selected PRACH occasion, corresponding RA-RNTI (if available), PREAMBLE_INDEX, and PREAMBLE_RECEIVED_TARGET_POWER.

5.1.4 Random Access Response Reception

Once the Random Access Preamble is transmitted and regardless of the possible occurrence of a measurement gap, the MAC entity shall:
1> if the contention-free Random Access Preamble for beam failure recovery request was transmitted by the MAC entity:
   2> start the ra-Response Window configured in BeamFailureRecoveryConfig at the first PDCCH occasion as specified in TS 38.213 [6] from the end of the Random Access Preamble transmission;
   2> monitor for a PDCCH transmission on the search space indicated by recoverySearchSpaceld of the SpCell identified by the C-RNTI while ra-Response Window is running
1> else:
   2> start the ra-Response Window configured in RACH-ConfigCommon at the first PDCCH occasion as specified in TS 38.213 [6] from the end of the Random Access Preamble transmission;
   2> monitor the PDCCH of the SpCell for Random Access Response(s) identified by the RA-RNTI while the ra-Response Window is running
1> if notification of a reception of a PDCCH transmission on the search space indicated by recoverySearchSpaceld is received from lower layers on the Serving Cell where the preamble was transmitted; and
1> if PDCCH transmission is addressed to the C-RNTI; and
1> if the contention-free Random Access Preamble for beam failure recovery request was transmitted by the MAC entity:
   2> consider the Random Access procedure successfully completed.
1> else if a valid (as specified in TS 38.213 [6]) downlink assignment has been received on the PDCCH for the RA-RNTI and the received TB is successfully decoded:
   2> if the Random Access Response contains a MAC subPDU with Backoff Indicator:
      3> set the PREAMBLE_BACKOFF to value of the BI field of the MAC subPDU using Table 7.2-1, multiplied with SCALING_FACTOR_BI.
   2> else:
      3> set the PREAMBLE_BACKOFF to 0 ms.
   2> if the Random Access Response contains a MAC subPDU with Random Access Preamble identifier corresponding to the transmitted PREAMBLE_INDEX (see clause 5.1.3):
      3> consider this Random Access Response reception successful.
   2> if the Random Access Response reception is considered successful:
      3> if the Random Access Response includes a MAC subPDU with RAPID only:
         4> consider this Random Access procedure successfully completed;
         4> indicate the reception of an acknowledgement for SI request to upper layers.
      3> else:
         4> apply the following actions for the Serving Cell where the Random Access Preamble was transmitted:
         5> process the received Timing Advance Command (see clause 5.2);
         5> indicate the preambleReceivedTargetPower and the amount of power ramping applied to the latest Random Access Preamble transmission to lower layers (i.e. (PREAMBLE_POWER_RAMPING_COUNTER−1)×PREAMBLE_POWER_RAMPING_STEP);
         5> if the Random Access procedure for an SCell is performed on uplink carrier where pusch-Config is not configured:
         6> ignore the received UL grant.
         5> else:
         6> process the received UL grant value and indicate it to the lower layers.
         4> if the Random Access Preamble was not selected by the MAC entity among the contention-based Random Access Preamble(s):
         5> consider the Random Access procedure successfully completed.
         4> else:
         5> set the TEMPORARY_C-RNTI to the value received in the Random Access Response;
         5> if this is the first successfully received Random Access Response within this Random Access procedure:
         6> if the transmission is not being made for the CCCH logical channel:
         7> indicate to the Multiplexing and assembly entity to include a C-RNTI MAC CE in the subsequent uplink transmission.
         6> if the Random Access procedure was initiated for SpCell beam failure recovery and spCell-BFR-CBRA with value true is configured:
         7> indicate to the Multiplexing and assembly entity to include a BFR MAC CE or a Truncated BFR MAC CE in the subsequent uplink transmission.
         6> obtain the MAC PDU to transmit from the Multiplexing and assembly entity and store it in the Msg3 buffer.

5.1.5 Contention Resolution

Once Msg3 is transmitted the MAC entity shall:
1> start the ra-ContentionResolutionTimer and restart the ra-ContentionResolutionTimer at each HARQ retransmission in the first symbol after the end of the Msg3 transmission;
1> monitor the PDCCH while the ra-ContentionResolutionTimer is running regardless of the possible occurrence of a measurement gap;
1> if notification of a reception of a PDCCH transmission of the SpCell is received from lower layers:
   2> if the C-RNTI MAC CE was included in Msg3:
      3> if the Random Access procedure was initiated for SpCell beam failure recovery (as specified in clause 5.17) and the PDCCH transmission is addressed to the C-RNTI; or
      3> if the Random Access procedure was initiated by a PDCCH order and the PDCCH transmission is addressed to the C-RNTI; or
      3> if the Random Access procedure was initiated by the MAC sublayer itself or by the RRC sublayer and the PDCCH transmission is addressed to the C-RNTI and contains a UL grant for a new transmission:
         4> consider this Contention Resolution successful;
         4> stop ra-ContentionResolutionTimer;
         4> discard the TEMPORARY_C-RNTI;
         4> consider this Random Access procedure successfully completed.
   2> else if the CCCH SDU was included in Msg3 and the PDCCH transmission is addressed to its TEMPORARY_C-RNTI:
      3> if the MAC PDU is successfully decoded:
         4> stop ra-ContentionResolutionTimer;
         4> if the MAC PDU contains a UE Contention Resolution Identity MAC CE; and
         4> if the UE Contention Resolution Identity in the MAC CE matches the CCCH SDU transmitted in Msg3:
         5> consider this Contention Resolution successful and finish the disassembly and demultiplexing of the MAC PDU;
         5> if this Random Access procedure was initiated for SI request:
         6> indicate the reception of an acknowledgement for SI request to upper layers.
         5> else:
         6> set the C-RNTI to the value of the TEMPORARY_C-RNTI;
         5> discard the TEMPORARY_C-RNTI;
         5> consider this Random Access procedure successfully completed.
         4> else:
         5> discard the TEMPORARY_C-RNTI;
         5> consider this Contention Resolution not successful and discard the successfully decoded MAC PDU.

5.1.6 Completion of the Random Access Procedure

Upon completion of the Random Access procedure, the MAC entity shall:
1> discard any explicitly signalled contention-free Random Access Resources for 2-step RA type and 4-step RA type except the 4-step RA type contention-free Random Access Resources for beam failure recovery request, if any;
1> flush the HARQ buffer used for transmission of the MAC PDU in the Msg3 buffer and the MSGA buffer.

5.2 Maintenance of Uplink Time Alignment

RRC configures the following parameters for the maintenance of UL time alignment:
timeAlignmentTimer (per TAG) which controls how long the MAC entity considers the Serving Cells belonging to the associated TAG to be uplink time aligned.

The MAC entity shall:
1> when a Timing Advance Command MAC CE is received, and if an N_{TA} (as defined in TS 38.211 [8]) has been maintained with the indicated TAG:
   2> apply the Timing Advance Command for the indicated TAG;
   2> start or restart the timeAlignmentTimer associated with the indicated TAG.
1> when a Timing Advance Command is received in a Random Access Response message for a Serving Cell belonging to a TAG or in a MSGB for an SpCell:
   2> if the Random Access Preamble was not selected by the MAC entity among the contention-based Random Access Preamble:
      3> apply the Timing Advance Command for this TAG;
      3> start or restart the timeAlignmentTimer associated with this TAG.
   2> else if the timeAlignmentTimer associated with this TAG is not running:
      3> apply the Timing Advance Command for this TAG;
      3> start the timeAlignmentTimer associated with this TAG;
      3> when the Contention Resolution is considered not successful as described in clause 5.1.5; or
      3> when the Contention Resolution is considered successful for SI request as described in clause 5.1.5, after transmitting HARQ feedback for MAC PDU including UE Contention Resolution Identity MAC CE:
         4> stop timeAlignmentTimer associated with this TAG.
   2> else:
      3> ignore the received Timing Advance Command.
1> when an Absolute Timing Advance Command is received in response to a MSGA transmission including C-RNTI MAC CE as specified in clause 5.1.4a:
   2> apply the Timing Advance Command for PTAG;
   2> start or restart the timeAlignmentTimer associated with PTAG.
1> when a timeAlignmentTimer expires:
   2> if the timeAlignmentTimer is associated with the PTAG:
      3> flush all HARQ buffers for all Serving Cells;
      3> notify RRC to release PUCCH for all Serving Cells, if configured;
      3> notify RRC to release SRS for all Serving Cells, if configured;
      3> clear any configured downlink assignments and configured uplink grants;
      3> clear any PUSCH resource for semi-persistent CSI reporting;
      3> consider all running timeAlignmentTimers as expired;
      3> maintain N_{TA} (defined in TS 38.211 [8]) of all TAGs.
   2> else if the timeAlignmentTimer is associated with an STAG, then for all Serving Cells belonging to this TAG:
      3> flush all HARQ buffers;
      3> notify RRC to release PUCCH, if configured;
      3> notify RRC to release SRS, if configured;
      3> clear any configured downlink assignments and configured uplink grants;
      3> clear any PUSCH resource for semi-persistent CSI reporting;
      3> maintain N_{TA} (defined in TS 38.211 [8]) of this TAG.

When the MAC entity stops uplink transmissions for an SCell due to the fact that the maximum uplink transmission timing difference between TAGs of the MAC entity or the maximum uplink transmission timing difference between TAGs of any MAC entity of the UE is exceeded, the MAC entity considers the timeAlignmentTimer associated with the SCell as expired.

The MAC entity shall not perform any uplink transmission on a Serving Cell except the Random Access Preamble and MSGA transmission when the timeAlignmentTimer associated with the TAG to which this Serving Cell belongs is not running. Furthermore, when the timeAlignmentTimer associated with the PTAG is not running, the MAC entity shall not perform any uplink transmission on any Serving Cell except the Random Access Preamble and MSGA transmission on the SpCell.

5.4.4 Scheduling Request

The Scheduling Request (SR) is used for requesting UL-SCH resources for new transmission.

The MAC entity may be configured with zero, one, or more SR configurations. An SR configuration consists of a set of PUCCH resources for SR across different BWPs and cells. For a logical channel or for SCell beam failure recovery (see clause 5.17) and for consistent LBT failure recovery (see clause 5.21), at most one PUCCH resource for SR is configured per BWP.

Each SR configuration corresponds to one or more logical channels and/or to SCell beam failure recovery and/or to consistent LBT failure recovery. Each logical channel, SCell beam failure recovery, and consistent LBT failure recovery, may be mapped to zero or one SR configuration, which is configured by RRC. The SR configuration of the logical channel that triggered a BSR (clause 5.4.5) or the SCell beam failure recovery or the consistent LBT failure recovery (clause 5.21) (if such a configuration exists) is considered as corresponding SR configuration for the triggered SR. Any SR configuration may be used for an SR triggered by Pre-emptive BSR (clause 5.4.7).

RRC configures the following parameters for the scheduling request procedure:
sr-ProhibitTimer (per SR configuration);
sr-TransMax (per SR configuration).

The following UE variables are used for the scheduling request procedure:
SR_COUNTER (per SR configuration).

If an SR is triggered and there are no other SRs pending corresponding to the same SR configuration, the MAC entity shall set the SR_COUNTER of the corresponding SR configuration to 0.

When an SR is triggered, it shall be considered as pending until it is cancelled.

All pending SR(s) for BSR triggered according to the BSR procedure (clause 5.4.5) prior to the MAC PDU assembly shall be cancelled and each respective sr-ProhibitTimer shall be stopped when the MAC PDU is transmitted and this PDU includes a Long or Short BSR MAC CE which contains buffer status up to (and including) the last event that triggered a BSR (see clause 5.4.5) prior to the MAC PDU assembly. All pending SR(s) for BSR triggered according to the BSR procedure (clause 5.4.5) shall be cancelled and each respective sr-ProhibitTimer shall be stopped when the UL grant(s) can accommodate all pending data available for transmission.

The MAC entity shall for each pending SR not triggered according to the BSR procedure (clause 5.4.5) for a Serving Cell:
1> if this SR was triggered by Pre-emptive BSR procedure (see clause 5.4.7) prior to the MAC PDU assembly and a MAC PDU containing the relevant Pre-emptive BSR MAC CE is transmitted; or
1> if this SR was triggered by beam failure recovery (see clause 5.17) of an SCell and a MAC PDU is transmitted and this PDU includes a BFR MAC CE or a Truncated BFR MAC CE which contains beam failure recovery information for this SCell; or
1> if this SR was triggered by beam failure recovery (see clause 5.17) of an SCell and this SCell is deactivated (see clause 5.9); or
1> if this SR was triggered by consistent LBT failure recovery (see clause 5.21) of an SCell and a MAC PDU is transmitted and the MAC PDU includes an LBT failure MAC CE that indicates consistent LBT failure for this SCell; or
1> if this SR was triggered by consistent LBT failure recovery (see clause 5.21) of an SCell and all the triggered consistent LBT failure(s) for this SCell are cancelled:
   2> cancel the pending SR and stop the corresponding sr-ProhibitTimer, if running Only PUCCH resources on a BWP which is active at the time of SR transmission occasion are considered valid. As long as at least one SR is pending, the MAC entity shall for each pending SR:
1> if the MAC entity has no valid PUCCH resource configured for the pending SR:
   2> initiate a Random Access procedure (see clause 5.1) on the SpCell and cancel the pending SR.
1> else, for the SR configuration corresponding to the pending SR:
   2> when the MAC entity has an SR transmission occasion on the valid PUCCH resource for SR configured; and
   2> if sr-ProhibitTimer is not running at the time of the SR transmission occasion; and
   2> if the PUCCH resource for the SR transmission occasion does not overlap with a measurement gap:
      3> if the PUCCH resource for the SR transmission occasion overlaps with neither a UL-SCH resource nor an SL-SCH resource; or
      3> if the MAC entity is able to perform this SR transmission simultaneously with the transmission of the SL-SCH resource; or
      3> if the MAC entity is configured with lch-basedPrioritization, and the PUCCH resource for the SR transmission occasion does not overlap with the PUSCH duration of an uplink grant received in a Random Access Response or with the PUSCH duration of an uplink grant addressed to Temporary C-RNTI or with the PUSCH duration of a MSGA payload, and the PUCCH resource for the SR transmission occasion for the pending SR triggered as specified in clause 5.4.5 overlaps with any other UL-SCH resource(s), and the physical layer can signal the SR on one valid PUCCH resource for SR, and the priority of the logical channel that triggered SR is higher than the priority of the uplink grant(s) for any UL-SCH resource(s) where the uplink grant was not already de-prioritized, and the priority of the uplink grant is determined as specified in clause 5.4.1; or
      3> if both sl-PrioritizationThres and ul-PrioritizationThres are configured and the PUCCH resource for the SR transmission occasion for the pending SR triggered as specified in clause 5.22.1.5 overlaps with any UL-SCH resource(s) carrying a MAC PDU, and the value of the priority of the triggered SR determined as specified in clause 5.22.1.5 is lower than sl-PrioritizationThres and the value of the highest priority of the logical channel(s) in the MAC PDU is higher than or equal to ul-PrioritizationThres and any MAC CE prioritized as described in clause 5.4.3.1.3 is not included in the MAC PDU and the MAC PDU is not prioritized by upper layer according to TS 23.287 [19]; or
      3> if a SL-SCH resource overlaps with the PUCCH resource for the SR transmission occasion for the pending SR triggered as specified in clause 5.4.5, and the MAC entity is not able to perform this SR transmission simultaneously with the transmission of the SL-SCH resource, and either transmission on the SL-SCH resource is not prioritized as described in clause 5.22.1.3.1a or the priority value of the logical channel that triggered SR is lower than ul-PrioritizationThres, if configured; or
      3> if a SL-SCH resource overlaps with the PUCCH resource for the SR transmission occasion for the pending SR triggered as specified in clause 5.22.1.5, and the MAC entity is not able to perform this SR transmission simultaneously with the transmission of the SL-SCH resource, and the priority of the triggered SR determined as specified in clause 5.22.1.5 is higher than the priority of the MAC PDU determined as specified in clause 5.22.1.3.1a for the SL-SCH resource:
         4> consider the SR transmission as a prioritized SR transmission.
         4> consider the other overlapping uplink grant(s), if any, as a de-prioritized uplink grant(s);
         4> if the de-prioritized uplink grant(s) is a configured uplink grant configured with autonomousTx whose PUSCH has already started:
         5> stop the configuredGrantTimer for the corresponding HARQ process of the de-prioritized uplink grant(s).
         4> if SR_COUNTER<sr-TransMax:
         5> instruct the physical layer to signal the SR on one valid PUCCH resource for SR;
         5> if LBT failure indication is not received from lower layers:
         6> increment SR_COUNTER by 1; 6> start the sr-ProhibitTimer.
         5> else if lbt-FailureRecoveryConfig is not configured:
         6> increment SR_COUNTER by 1.
         4> else:
         5> notify RRC to release PUCCH for all Serving Cells;
         5> notify RRC to release SRS for all Serving Cells;
         5> clear any configured downlink assignments and uplink grants;
         5> clear any PUSCH resources for semi-persistent CSI reporting;
         5> initiate a Random Access procedure (see clause 5.1) on the SpCell and cancel all pending SRs.
      3> else:
         4> consider the SR transmission as a de-prioritized SR transmission.
NOTE 1: Except for SR for SCell beam failure recovery, the selection of which valid PUCCH resource for SR to signal SR on when the MAC entity has more than one overlapping valid PUCCH resource for the SR transmission occasion is left to UE implementation.
NOTE 2: If more than one individual SR triggers an instruction from the MAC entity to the PHY layer to signal the SR on the same valid PUCCH resource, the SR_COUNTER for the relevant SR configuration is incremented only once.
NOTE 3: When the MAC entity has pending SR for SCell beam failure recovery and the MAC entity has one or more PUCCH resources overlapping with PUCCH resource for SCell beam failure recovery for the SR transmission occasion, the MAC entity considers only the PUCCH resource for SCell beam failure recovery as valid.
NOTE 4: For a UE operating in a semi-static channel access mode as described in TS 37.213 [18], PUCCH resources overlapping with the set of consecutive symbols where the UE does not transmit before the start of a next channel occupancy time are not considered valid.
NOTE 5: If the MAC entity is configured with lch-basedPrioritization, the MAC entity does not take UCI multiplexing according to the procedure specified in TS 38.213 [6] into account when determining whether the valid PUCCH resource for the SR transmission can be signalled by the physical layer and the SR transmission occasion overlaps with the PUSCH duration of an uplink grant of a MSGA payload.

The MAC entity may stop, if any, ongoing Random Access procedure due to a pending SR for BSR, which was initiated by the MAC entity prior to the MAC PDU assembly and which has no valid PUCCH resources configured, if:
a MAC PDU is transmitted using a UL grant other than a UL grant provided by Random Access Response or a UL grant determined as specified in clause 5.1.2a for the transmission of the MSGA payload, and this PDU includes a BSR MAC CE which contains buffer status up to (and including) the last event that triggered a BSR (see clause 5.4.5) prior to the MAC PDU assembly; or
the UL grant(s) can accommodate all pending data available for transmission.

The MAC entity may stop, if any, ongoing Random Access procedure due to a pending SR for SL-BSR and/or SL-CSI reporting, which was initiated by the MAC entity prior to the sidelink MAC PDU assembly and which has no valid PUCCH resources configured, if:
a MAC PDU is transmitted using a UL grant other than a UL grant provided by Random Access Response or a UL grant determined as specified in clause 5.1.2a for the transmission of the MSGA payload, and this PDU includes a SL-BSR MAC CE which contains buffer status up to (and including) the last event that triggered a SL-BSR (see clause 5.22.1.6) prior to the MAC PDU assembly; or
the SL grant(s) can accommodate all pending data available and/or SL-CSI reporting MAC CE for transmission.

The MAC entity may stop, if any, ongoing Random Access procedure due to a pending SR for BFR of an SCell, which has no valid PUCCH resources configured, if:
a MAC PDU is transmitted using a UL grant other than a UL grant provided by Random Access Response or a UL grant determined as specified in clause 5.1.2a for the transmission of the MSGA payload, and this PDU contains a BFR MAC CE or a Truncated BFR MAC CE which includes beam failure recovery information of that SCell; or
the SCell is deactivated (as specified in clause 5.9) and all triggered BFRs for SCells are cancelled.

The MAC entity may stop, if any, ongoing Random Access procedure due to a pending SR for consistent LBT failure recovery, which has no valid PUCCH resources configured, if:
a MAC PDU is transmitted using a UL grant other than a UL grant provided by Random Access Response or a UL grant determined as specified in clause 5.1.2a for the transmission of the MSGA payload, and this PDU includes an LBT failure MAC CE that indicates consistent LBT failure for all the SCells that triggered consistent LBT failure; or
all the SCells that triggered consistent LBT failure recovery are deactivated (see clause 5.9).

5.7 Discontinuous Reception (DRX)

The MAC entity may be configured by RRC with a DRX functionality that controls the UE's PDCCH monitoring activity for the MAC entity's C-RNTI, CI-RNTI, CS-RNTI, INT-RNTI, SFI-RNTI, SP-CSI-RNTI, TPC-PUCCH-RNTI, TPC-PUSCH-RNTI, TPC-SRS-RNTI, and AI-RNTI. When using DRX operation, the MAC entity shall also monitor PDCCH according to requirements found in other clauses of this specification. When in RRC_CONNECTED, if DRX is configured, for all the activated Serving Cells, the MAC entity may monitor the PDCCH discontinuously using the DRX operation specified in this clause; otherwise the MAC entity shall monitor the PDCCH as specified in TS 38.213 [6].
NOTE 1: If Sidelink resource allocation mode 1 is configured by RRC, a DRX functionality is not configured. RRC controls DRX operation by configuring the following parameters:
   drx-onDurationTimer: the duration at the beginning of a DRX cycle;
   drx-SlotOffset: the delay before starting the drx-onDurationTimer;
   drx-InactivityTimer: the duration after the PDCCH occasion in which a PDCCH indicates a new UL or DL transmission for the MAC entity;
   drx-RetransmissionTimerDL (per DL HARQ process except for the broadcast process): the maximum duration until a DL retransmission is received;
   drx-RetransmissionTimerUL (per UL HARQ process): the maximum duration until a grant for UL retransmission is received;
   drx-LongCycleStartOffset: the Long DRX cycle and drx-StartOffset which defines the subframe where the Long and Short DRX cycle starts;
   drx-ShortCycle (optional): the Short DRX cycle;
   drx-ShortCycleTimer (optional): the duration the UE shall follow the Short DRX cycle;
   drx-HARQ-RTT-TimerDL (per DL HARQ process except for the broadcast process): the minimum duration before a DL assignment for HARQ retransmission is expected by the MAC entity;
   drx-HARQ-RTT-TimerUL (per UL HARQ process): the minimum duration before a UL HARQ retransmission grant is expected by the MAC entity;
   ps-Wakeup (optional): the configuration to start associated drx-onDurationTimer in case DCP is monitored but not detected;
   ps-TransmitOtherPeriodicCSI (optional): the configuration to report periodic CSI that is not L1-RSRP on PUCCH during the time duration indicated by drx-onDurationTimer in case DCP is configured but associated drx-onDurationTimer is not started;
   ps-TransmitPeriodicL1-RSRP (optional): the configuration to transmit periodic CSI that is L1-RSRP on PUCCH during the time duration indicated by drx-onDurationTimer in case DCP is configured but associated drx-onDurationTimer is not started.

Serving Cells of a MAC entity may be configured by RRC in two DRX groups with separate DRX parameters. When RRC does not configure a secondary DRX group, there is only one DRX group and all Serving Cells belong to that one DRX group. When two DRX groups are configured, each Serving Cell is uniquely assigned to either of the two groups. The DRX parameters that are separately configured for each DRX group are: drx-onDurationTimer, drx-InactivityTimer. The DRX parameters that are common to the DRX groups are: drx-Slot Offset, drx-RetransmissionTimerDL, drx-RetransmissionTimerUL, drx-LongCycleStartOffset, drx-ShortCycle (optional), drx-ShortCycleTimer (optional), drx-HARQ-RTT-TimerDL, and drx-HARQ-RTT-TimerUL.

When DRX is configured, the Active Time for Serving Cells in a DRX group includes the time while:
drx-onDurationTimer or drx-InactivityTimer configured for the DRX group is running; or
drx-RetransmissionTimerDL or drx-RetransmissionTimerUL is running on any Serving Cell in the DRX group; or
ra-ContentionResolutionTimer (as described in clause 5.1.5) or msgB-Response Window (as described in clause 5.1.4a) is running; or
a Scheduling Request is sent on PUCCH and is pending (as described in clause 5.4.4); or
a PDCCH indicating a new transmission addressed to the C-RNTI of the MAC entity has not been received after successful reception of a Random Access Response for the Random Access Preamble not selected by the MAC entity among the contention-based Random Access Preamble (as described in clauses 5.1.4 and 5.1.4a).

5.9 Activation/Deactivation of SCells

If the MAC entity is configured with one or more SCells, the network may activate and deactivate the configured SCells. Upon configuration of an SCell, the SCell is deactivated unless the parameter sCellState is set to activated for the SCell by upper layers.

The configured SCell(s) is activated and deactivated by:
receiving the SCell Activation/Deactivation MAC CE described in clause 6.1.3.10;
configuring sCellDeactivationTimer timer per configured SCell (except the SCell configured with PUCCH, if any): the associated SCell is deactivated upon its expiry;
configuring sCellState per configured SCell: if configured, the associated SCell is activated upon SCell configuration.

The MAC entity shall for each configured SCell:
1> if an SCell is configured with sCellState set to activated upon SCell configuration, or an SCell Activation/Deactivation MAC CE is received activating the SCell:
   2> if the SCell was deactivated prior to receiving this SCell Activation/Deactivation MAC CE; or
   2> if the SCell is configured with sCellState set to activated upon SCell configuration:
      3> if firstActiveDownlinkBWP-Id is not set to dormant BWP:
         4> activate the SCell according to the timing defined in TS 38.213 [6] for MAC CE activation and according to the timing defined in TS 38.133 [11] for direct SCell activation; i.e. apply normal SCell operation including:
         5> SRS transmissions on the SCell;
         5> CSI reporting for the SCell;
         5> PDCCH monitoring on the SCell;
         5> PDCCH monitoring for the SCell;
         5> PUCCH transmissions on the SCell, if configured.
      3> else (i.e. firstActiveDownlinkBWP-Id is set to dormant BWP):
         4> stop the bwp-InactivityTimer of this Serving Cell, if running.
      3> activate the DL BWP and UL BWP indicated by firstActiveDownlinkBWP-Id and firstActiveUplinkBWP-Id respectively.
   2> start or restart the sCellDeactivationTimer associated with the SCell according to the timing defined in TS 38.213 [6] for MAC CE activation and according to the timing defined in TS 38.133 [11] for direct SCell activation;
   2> if the active DL BWP is not the dormant BWP:
      3> (re-)initialize any suspended configured uplink grants of configured grant Type 1 associated with this SCell according to the stored configuration, if any, and to start in the symbol according to rules in clause 5.8.2;
      3> trigger PHR according to clause 5.4.6.
1> else if an SCell Activation/Deactivation MAC CE is received deactivating the SCell; or
1> if the sCellDeactivationTimer associated with the activated SCell expires:
   2> deactivate the SCell according to the timing defined in TS 38.213 [6];
   2> stop the sCellDeactivationTimer associated with the SCell;
   2> stop the bwp-InactivityTimer associated with the SCell;
   2> deactivate any active BWP associated with the SCell;
   2> clear any configured downlink assignment and any configured uplink grant Type 2 associated with the SCell respectively;
   2> clear any PUSCH resource for semi-persistent CSI reporting associated with the SCell;
   2> suspend any configured uplink grant Type 1 associated with the SCell;
   2> flush all HARQ buffers associated with the SCell;
   2> cancel, if any, triggered consistent LBT failure for the SCell.
1> if PDCCH on the activated SCell indicates an uplink grant or downlink assignment; or
1> if PDCCH on the Serving Cell scheduling the activated SCell indicates an uplink grant or a downlink assignment for the activated SCell; or
1> if a MAC PDU is transmitted in a configured uplink grant and LBT failure indication is not received from lower layers; or
1> if a MAC PDU is received in a configured downlink assignment:
   2> restart the sCellDeactivationTimer associated with the SCell.
1> if the SCell is deactivated:
   2> not transmit SRS on the SCell;
   2> not report CSI for the SCell;
   2> not transmit on UL-SCH on the SCell;
   2> not transmit on RACH on the SCell;
   2> not monitor the PDCCH on the SCell;
   2> not monitor the PDCCH for the SCell;
   2> not transmit PUCCH on the SCell.

HARQ feedback for the MAC PDU containing SCell Activation/Deactivation MAC CE shall not be impacted by PCell, PSCell and PUCCH SCell interruptions due to SCell activation/deactivation in TS 38.133 [11].

When SCell is deactivated, the ongoing Random Access procedure on the SCell, if any, is aborted.

5.12 MAC Reset

If a reset of the MAC entity is requested by upper layers, the MAC entity shall:
1> initialize Bj for each logical channel to zero;
1> initialize SBj for each logical channel to zero if Sidelink resource allocation mode 1 is configured by RRC;
1> stop (if running) all timers;
1> consider all timeAlignmentTimers as expired and perform the corresponding actions in clause 5.2;
1> set the NDIs for all uplink HARQ processes to the value 0;
1> sets the NDIs for all HARQ process IDs to the value 0 for monitoring PDCCH in Sidelink resource allocation mode 1;
1> stop, if any, ongoing Random Access procedure;
1> discard explicitly signalled contention-free Random Access Resources for 4-step RA type and 2-step RA type, if any;
1> flush Msg3 buffer;
1> flush MSGA buffer;
1> cancel, if any, triggered Scheduling Request procedure;
1> cancel, if any, triggered Buffer Status Reporting procedure;
1> cancel, if any, triggered Power Headroom Reporting procedure;
1> cancel, if any, triggered consistent LBT failure;
1> cancel, if any, triggered BFR;
1> cancel, if any, triggered Sidelink Buffer Status Reporting procedure;
1> cancel, if any, triggered Pre-emptive Buffer Status Reporting procedure;
1> cancel, if any, triggered Recommended bit rate query procedure;
1> cancel, if any, triggered Configured uplink grant confirmation;
1> cancel, if any, triggered configured sidelink grant confirmation;
1> cancel, if any, triggered Desired Guard Symbol query;
1> flush the soft buffers for all DL HARQ processes;
1> for each DL HARQ process, consider the next received transmission for a TB as the very first transmission;
1> release, if any, Temporary C-RNTI;
1> reset all BFI_COUNTERs;
1> reset all LBT_COUNTERs.

5.17 Beam Failure Detection and Recovery Procedure

The MAC entity may be configured by RRC per Serving Cell with a beam failure recovery procedure which is used for indicating to the serving gNB of a new SSB or CSI-RS when beam failure is detected on the serving SSB(s)/CSI-RS(s). Beam failure is detected by counting beam failure instance indication from the lower layers to the MAC entity. If beamFailureRecoveryConfig is reconfigured by upper layers during an ongoing Random Access procedure for beam failure recovery for SpCell, the MAC entity shall stop the ongoing Random Access procedure and initiate a Random Access procedure using the new configuration.

RRC configures the following parameters in the BeamFailureRecoveryConfig, BeamFailureRecoverySCellConfig, and the RadioLinkMonitoringConfig for the Beam Failure Detection and Recovery procedure:
beamFailureInstanceMaxCount for the beam failure detection;
beamFailureDetectionTimer for the beam failure detection;
beamFailureRecoveryTimer for the beam failure recovery procedure;
rsrp-ThresholdSSB: an RSRP threshold for the SpCell beam failure recovery;
rsrp-ThresholdBFR: an RSRP threshold for the SCell beam failure recovery;
powerRampingStep: powerRampingStep for the SpCell beam failure recovery;
powerRampingStepHighPriority: powerRampingStepHighPriority for the SpCell beam failure recovery;
preambleReceivedTargetPower: preambleReceivedTargetPower for the SpCell beam failure recovery;
preambleTransMax: preambleTransMax for the SpCell beam failure recovery;
scalingFactorBl: scalingFactorBl for the SpCell beam failure recovery;
ssb-perRACH-Occasion: ssb-perRACH-Occasion for the SpCell beam failure recovery using contention-free Random Access Resources;
ra-Response Window: the time window to monitor response(s) for the SpCell beam failure recovery using contention-free Random Access Resources;
prach-ConfigurationIndex: prach-ConfigurationIndex for the SpCell beam failure recovery using contention-free

Random Access Resources;
ra-ssb-OccasionMaskIndex: ra-ssb-OccasionMaskIndex for the SpCell beam failure recovery using contention-free Random Access Resources;
ra-OccasionList: ra-OccasionList for the SpCell beam failure recovery using contention-free Random Access

Resources;
candidateBeamRSList: list of candidate beams for SpCell beam failure recovery;
candidateBeamRSSCellList: list of candidate beams for SCell beam failure recovery.

The following UE variables are used for the beam failure detection procedure:
BFI_COUNTER (per Serving Cell): counter for beam failure instance indication which is initially set to 0.

The MAC entity shall for each Serving Cell configured for beam failure detection:
1> if beam failure instance indication has been received from lower layers:
   2> start or restart the beamFailureDetectionTimer;
   2> increment BFI_COUNTER by 1; 2> if BFI_COUNTER>=beamFailureInstanceMaxCount:
      3> if the Serving Cell is SCell:
         4> trigger a BFR for this Serving Cell;
      3> else:
         4> initiate a Random Access procedure (see clause 5.1) on the SpCell.
1> if the beamFailureDetectionTimer expires; or
1> if beamFailureDetectionTimer, beamFailureInstanceMaxCount, or any of the reference signals used for beam failure detection is reconfigured by upper layers associated with this Serving Cell:
   2> set BFI_COUNTER to 0.
1> if the Serving Cell is SpCell and the Random Access procedure initiated for SpCell beam failure recovery is successfully completed (see clause 5.1):
   2> set BFI_COUNTER to 0;
   2> stop the beamFailureRecoveryTimer, if configured;
   2> consider the Beam Failure Recovery procedure successfully completed.
1> else if the Serving Cell is SCell, and a PDCCH addressed to C-RNTI indicating uplink grant for a new transmission is received for the HARQ process used for the transmission of the BFR MAC CE or Truncated BFR MAC CE which contains beam failure recovery information of this Serving Cell; or
1> if the SCell is deactivated as specified in clause 5.9:
   2> set BFI_COUNTER to 0;
   2> consider the Beam Failure Recovery procedure successfully completed and cancel all the triggered BFRs for this Serving Cell.

The MAC entity shall:
1> if the Beam Failure Recovery procedure determines that at least one BFR has been triggered and not cancelled for an SCell for which evaluation of the candidate beams according to the requirements as specified in TS 38.133 [11] has been completed:
   2> if UL-SCH resources are available for a new transmission and if the UL-SCH resources can accommodate the BFR MAC CE plus its subheader as a result of LCP:
      3> instruct the Multiplexing and Assembly procedure to generate the BFR MAC CE.
   2> else if UL-SCH resources are available for a new transmission and if the UL-SCH resources can accommodate the Truncated BFR MAC CE plus its subheader as a result of LCP:
      3> instruct the Multiplexing and Assembly procedure to generate the Truncated BFR MAC CE.
   2> else:
      3> trigger the SR for SCell beam failure recovery for each SCell for which BFR has been triggered, not cancelled, and for which evaluation of the candidate beams according to the requirements as specified in TS 38.133 [11] has been completed.

All BFRs triggered for an SCell shall be cancelled when a MAC PDU is transmitted and this PDU includes a BFR MAC CE or Truncated BFR MAC CE which contains beam failure information of that SCell.

5.18.4 Activation/Deactivation of UE-Specific PDSCH TCI State

The network may activate and deactivate the configured TCI states for PDSCH of a Serving Cell or a set of Serving Cells configured in simultaneousTCI-UpdateList1 or simultaneousTCI-UpdateList2 by sending the TCI States Activation/Deactivation for UE-specific PDSCH MAC CE described in clause 6.1.3.14. The network may activate and deactivate the configured TCI states for a codepoint of the DCI Transmission configuration indication field as specified in TS 38.212 [9] for PDSCH of a Serving Cell by sending the Enhanced TCI States Activation/Deactivation for UE-specific PDSCH MAC CE described in clause 6.1.3.24. The configured TCI states for PDSCH are initially deactivated upon configuration and after a handover.

The MAC entity shall:
1> if the MAC entity receives a TCI States Activation/Deactivation for UE-specific PDSCH MAC CE on a Serving Cell:
   2> indicate to lower layers the information regarding the TCI States Activation/Deactivation for UE-specific PDSCH MAC CE.
1> if the MAC entity receives an Enhanced TCI States Activation/Deactivation for UE-specific PDSCH MAC CE on a Serving Cell:
   2> indicate to lower layers the information regarding the Enhanced TCI States Activation/Deactivation for UE-specific PDSCH MAC CE.

5.18.5 Indication of TCI State for UE-Specific PDCCH

The network may indicate a TCI state for PDCCH reception for a CORESET of a Serving Cell or a set of Serving Cells configured in simultaneousTCI-UpdateList1 or simultaneousTCI-UpdateList2 by sending the TCI State Indication for UE-specific PDCCH MAC CE described in clause 6.1.3.15.

The MAC entity shall:
1> if the MAC entity receives a TCI State Indication for UE-specific PDCCH MAC CE on a Serving Cell:
   2> indicate to lower layers the information regarding the TCI State Indication for UE-specific PDCCH MAC CE.

5.18.7 Activation/Deactivation of Semi-Persistent SRS and Indication of Spatial Relation of SP/AP SRS

The network may activate and deactivate the configured Semi-persistent SRS resource sets of a Serving Cell by sending the SP SRS Activation/Deactivation MAC CE described in clause 6.1.3.17. The network may also activate and deactivate the configured Semi-persistent SRS resource sets of a Serving Cell by sending the Enhanced SP/AP SRS Spatial Relation Indication MAC CE described in clause 6.1.3.26. The configured Semi-persistent SRS resource sets are initially deactivated upon configuration and after a handover. The network may indicate the spatial relation info of SP/AP SRS resource sets of a Serving Cell by sending the Enhanced SP/AP SRS spatial relation Indication MAC CE described in clause 6.1.3.26.

The MAC entity shall:
1> if the MAC entity receives an SP SRS Activation/Deactivation MAC CE on a Serving Cell:
   2> indicate to lower layers the information regarding the SP SRS Activation/Deactivation MAC CE.
1> if the MAC entity receives an Enhanced SP/AP SRS Spatial Relation Indication MAC CE on a Serving Cell:
   2> indicate to lower layers the information regarding the Enhanced SP/AP SRS Spatial Relation Indication MAC CE.

5.18.8 Activation/Deactivation of Spatial Relation of PUCCH Resource

The network may activate and deactivate a spatial relation for a PUCCH resource of a Serving Cell by sending the PUCCH spatial relation Activation/Deactivation MAC CE described in clause 6.1.3.18. The network may also activate and deactivate a spatial relation for a PUCCH resource or a PUCCH resource group of a Serving Cell by sending the Enhanced PUCCH spatial relation Activation/Deactivation MAC CE described in clause 6.1.3.25.

The MAC entity shall:
1> if the MAC entity receives a PUCCH spatial relation Activation/Deactivation MAC CE on a Serving Cell:
   2> indicate to lower layers the information regarding the PUCCH spatial relation Activation/Deactivation MAC CE.
1> if the MAC entity receives an Enhanced PUCCH spatial relation Activation/Deactivation MAC CE on a Serving Cell:
   2> indicate to lower layers the information regarding the Enhanced PUCCH spatial relation Activation/Deactivation MAC CE.

6.1.3.14 TCI States Activation/Deactivation for UE-specific PDSCH MAC CE

The TCI States Activation/Deactivation for UE-specific PDSCH MAC CE is identified by a MAC subheader with LCID as specified in Table 6.2.1-1. It has a variable size consisting of following fields:
Serving Cell ID: This field indicates the identity of the Serving Cell for which the MAC CE applies. The length of the field is 5 bits. If the indicated Serving Cell is configured as part of a simultaneousTCI-UpdateList1 or simultaneousTCI-UpdateList2 as specified in TS 38.331 [5], this MAC CE applies to all the Serving Cells configured in the set simultaneousTCI-UpdateList1 or simultaneousTCI-UpdateList2, respectively;
BWP ID: This field indicates a DL BWP for which the MAC CE applies as the codepoint of the DCI bandwidth part indicator field as specified in TS 38.212 [9]. The length of the BWP ID field is 2 bits. This field is ignored if this MAC CE applies to a set of Serving Cells;
Tᵢ: If there is a TCI state with TCI-StateId i as specified in TS 38.331 [5], this field indicates the activation/deactivation status of the TCI state with TCI-StateId i, otherwise MAC entity shall ignore the Tᵢ field. The Tᵢ field is set to 1 to indicate that the TCI state with TCI-StateId i shall be activated and mapped to the codepoint of the DCI Transmission Configuration Indication field, as specified in TS 38.214 [7]. The Tᵢ field is set to 0 to indicate that the TCI state with TCI-StateId i shall be deactivated and is not mapped to the codepoint of the DCI Transmission Configuration Indication field. The codepoint to which the TCI State is mapped is determined by its ordinal position among all the TCI States with Tᵢ field set to 1, i.e. the first TCI State with Tᵢ field set to 1 shall be mapped to the codepoint value 0, second TCI State with Tᵢ field set to 1 shall be mapped to the codepoint value 1 and so on. The maximum number of activated TCI states is 8;
CORESET Pool ID: This field indicates that mapping between the activated TCI states and the codepoint of the DCI Transmission Configuration Indication set by field Tᵢ is specific to the ControlResourceSetId configured with CORESET Pool ID as specified in TS 38.331 [5]. This field set to 1 indicates that this MAC CE shall be applied for the DL transmission scheduled by CORESET with the CORESET pool ID equal to 1, otherwise, this MAC CE shall be applied for the DL transmission scheduled by CORESET pool ID equal to 0. If the coresetPoolIndex is not configured for any CORESET, MAC entity shall ignore the CORESET Pool ID field in this MAC CE when receiving the MAC CE. If the Serving Cell in the MAC CE is configured in a cell list that contains more than one Serving Cell, the CORSET Pool ID field shall be ignored when receiving the MAC CE.

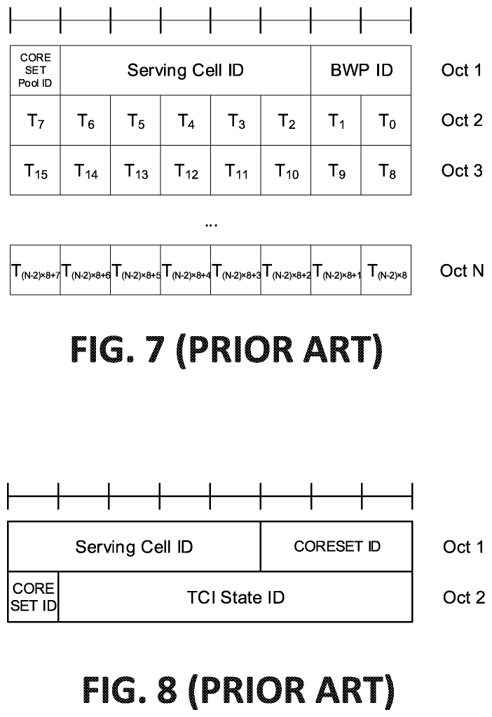

FIG. 7 is a reproduction of FIG. 6.1.3.14-1: TCI States Activation/Deactivation for UE-specific PDSCH MAC CE, from [3] 3GPP specification 38.321 v16.7.0.

6.1.3.15 TCI State Indication for UE-Specific PDCCH MAC CE

The TCI State Indication for UE-specific PDCCH MAC CE is identified by a MAC subheader with LCID as specified in Table 6.2.1-1. It has a fixed size of 16 bits with following fields:
Serving Cell ID: This field indicates the identity of the Serving Cell for which the MAC CE applies. The length of the field is 5 bits. If the indicated Serving Cell is configured as part of a simultaneousTCI-UpdateList1 or simultaneousTCI-UpdateList2 as specified in TS 38.331 [5], this MAC CE applies to all the Serving Cells in the set simultaneousTCI-UpdateList1 or simultaneousTCI-UpdateList2, respectively;
CORESET ID: This field indicates a Control Resource Set identified with ControlResourceSetId as specified in TS 38.331 [5], for which the TCI State is being indicated. In case the value of the field is 0, the field refers to the Control Resource Set configured by controlResourceSetZero as specified in TS 38.331 [5]. The length of the field is 4 bits;
TCI State ID: This field indicates the TCI state identified by TCI-StateId as specified in TS 38.331 [5] applicable to the Control Resource Set identified by CORESET ID field. If the field of CORESET ID is set to 0, this field indicates a TCI-StateId for a TCI state of the first 64 TCI-states configured by tci-StatesToAddModList and tci-StatesToReleaseList in the PDSCH-Config in the active BWP. If the field of CORESET ID is set to the other value than 0, this field indicates a TCI-StateId configured by tci-StatesPDCCH-ToAddList and tci-StatesPDCCH-ToReleaseList in the controlResourceSet identified by the indicated CORESET ID. The length of the field is 7 bits.

FIG. 8 is a reproduction of FIG. 6.1.3.15-1: TCI State Indication for UE-specific PDCCH MAC CE, from 3GPP specification 38.321 v16.7.0.

In 38.304 ([4] 3GPP specification 38.304 v16.7.0), Cell selection is introduced:

5.2.3 Cell Selection Process

5.2.3.1 Description

Cell selection is performed by one of the following two procedures:
a) Initial cell selection (no prior knowledge of which RF channels are NR frequencies):
   1. The UE shall scan all RF channels in the NR bands according to its capabilities to find a suitable cell.
   2. On each frequency, the UE need only search for the strongest cell, except for operation with shared spectrum channel access where the UE may search for the next strongest cell(s).
   3. Once a suitable cell is found, this cell shall be selected.
b) Cell selection by leveraging stored information:
   1. This procedure requires stored information of frequencies and optionally also information on cell parameters from previously received measurement control information elements or from previously detected cells.
   2. Once the UE has found a suitable cell, the UE shall select it.
   3. If no suitable cell is found, the initial cell selection procedure in a) shall be started.
NOTE: Priorities between different frequencies or RATs provided to the UE by system information or dedicated signalling are not used in the cell selection process.

In New Radio (N_{R}), a User Equipment (UE) performs a handover procedure to switch from one cell (e.g., a source Cell) to another cell (e.g., a target Cell). The UE performs the handover procedure in response to a Radio Resource Control (RRC) signaling transmitted by a network. The RRC signaling contains cell information of a target cell. The network determines to initiate the handover procedure based on measurement reports of the UE. Change of Primary Cell (PCell) and Primary and Secondary Cell (PSCell) via reconfiguration with sync (e.g., involving Layer-3 RRC message) involves high latency and more overhead than L1/L2 signaling (e.g., beam switch mobility). In addition, in operation on Frequency Range 2 (FR2), frequent Secondary Cell Group (SCG) changes will occur, which could also lead to high latency for UE-Network (NW) communication if L3 Handover is used. Therefore, in WID for NR mobility enhancements (e.g., [1] RP-212710 NR further mobility enhancements), an objective of the work item is to specify mechanisms and procedures (e.g., a L1/L2 mobility procedure, or mobility procedure) for dynamic switching mechanisms among serving cells, including Special Cell(s) (SpCell) and/or Secondary Cell(s) (SCell) based on L1/L2 signaling. The serving cells could include a target Cell of the mobility procedure and one or more Secondary Cells (to be added or released) in the mobility procedure. A mobility procedure could consist of the gNB of the source Cell providing a first information and a second information.

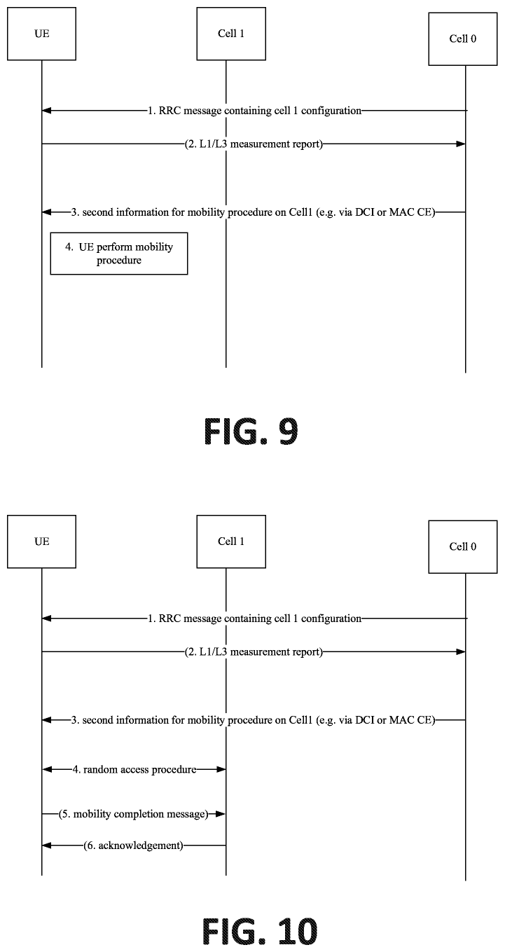

An example is shown in FIG. 9. The UE receives a first information (e.g., step 1 RRC message) containing cell 1 configuration from Cell 0. The UE could perform RRC connection with Cell 0. The Cell 1 configuration could contain Serving Cell configuration of Celli. The Cell 1 could be a neighboring cell, a Secondary Cell, or a Primary Cell of the UE. The UE could transmit a L1/L3 measurement report to Cell 0 (including measurement associated with Cell 1). The Cell 0 could transmit a second information (e.g., step 3 Downlink Control Information (DCI) or Medium Access Control (MAC) Control Element (CE) to the UE for initiating a mobility procedure associated with Cell 1. In response to receiving the second information, the UE could initiate or perform a mobility procedure associated with Cell 1. Corresponding to various setup for the information and procedure, the UE could perform various procedures to Cell 1 (e.g., SCell addition/release; PCell switching, etc). The UE could consider the Cell 1 as a (activated) PCell or a SCell (in Master Cell Group (MCG) or Secondary Cell Group (SCG)) in response to completion of the mobility procedure (or in response to receiving the second information).

The second information could indicate one or more Cells or Cell Groups (CGs) that needs to be changed (added/activated/removed/released). The second information could indicate a target Cell for the UE to switch its Special Cell to. In response to or when receiving a second information, the UE could be able to know the target one or more Cells or CGs and/or its target Cell for mobility procedure. Additionally and/or alternatively, in response to the second information, the UE could be able to know which beam(s) to use for transmission/reception with the one or more Cells or CGs (during completion of a mobility procedure). The UE could transmit an (positive) acknowledgement (e.g., a MAC CE) to the source Cell in response to receiving the second information.

The mobility procedure could comprise one or more of following actions (and may not comprise the one or more of following other actions).
The UE could initiate a random access procedure to a Cell in the one or more Cells or CGs. The Cell could be a target Cell of the mobility procedure. The UE could consider the mobility procedure to be completed in response to (successful) completion of the random access procedure. The UE could consider the Cell to be a Primary Cell (PCell) or a Special Cell (SpCell) in response to completion of the random access procedure and/or completion of the mobility procedure.
The UE could transmit a mobility completion message to a Cell in the one or more Cells or CGs. The Cell could be a target Cell of the mobility procedure. The UE could transmit the mobility completion message to the Cell via an Uplink (UL) grant provided/scheduled by a Source Cell or via a gNB associated with the Source Cell. Additionally and/or alternatively, the UE could transmit the mobility completion message to the Cell via a UL grant provided/scheduled by the (target) Cell or by a gNB associated with the (target) Cell.
The UE could receive an acknowledgement from a Cell in the one or more Cells or CGs. The Cell could be a target Cell of the mobility procedure. The acknowledgement could be a signaling associated with the mobility completion message. The acknowledgement could be a signaling associated with completion of the mobility procedure.

An example is shown in FIG. 10. The UE could be configured with/activated with a Serving Cell 0 (e.g., a SpCell or a Secondary Cell). The UE could receive a RRC message (e.g., first information above) indicating configuration of Cell 1. The UE could (optionally) perform measurement on Cell 1 and transmit measurement report of Cell 1 to the network of Cell 0. The network (e.g., gNB) of Cell 0 could transmit a second information (e.g., based on measurement report from the UE) for the UE to initiate a mobility procedure to Cell 1. The mobility procedure comprises initiating a random access procedure to Cell 1. The mobility procedure could (or may not) comprise the UE transmitting a mobility completion message to the Cell 1. The mobility procedure could (or may not) comprise the Cell 1 transmitting an acknowledgement to the UE. The UE could consider the mobility procedure to be completed in response to (successful) completion of random access procedure. Additionally and/or alternatively, the UE could consider the mobility procedure to be completed in response to receiving the acknowledgement. The mobility completion message could be transmitted during the random access procedure (e.g., transmitted via Msg3) or could be transmitted independent of or after the random access procedure. The acknowledgement could be transmitted during the random access procedure (e.g., transmitted via Msg4 or Msg2) or could be transmitted independent of or after the random access procedure.

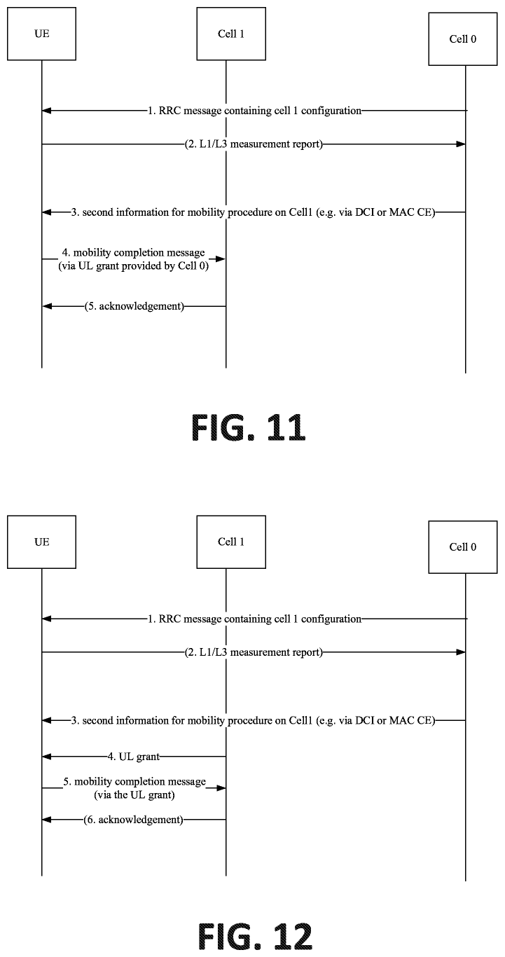

Another example is shown in FIG. 11. In response to receiving a second information for mobility procedure, the UE initiates/performs a mobility procedure to Cell 1. The UE may not initiate a random access procedure for the mobility procedure. The mobility procedure does not contain a random access procedure. The mobility procedure could contain the UE transmit a mobility completion message to Cell 1 via a UL grant. The UL grant could be scheduled by network associated with Cell 0 (source Cell). The UL grant could be provided/configured in the first information. Additionally and/or alternatively, the UL grant could be provided/indicated in the second information. Additionally and/or alternatively, the UL grant could be configured by the first information and activated by the second information.

Another example is shown in FIG. 12. A network associated with the Cell 1 could provide or schedule a UL grant to the UE during or before the mobility procedure indicated by second information from network of the Cell 0. The UE could transmit a mobility completion message to the Cell 1. The UE could consider the mobility procedure to be completed when transmitting the mobility completion message or when receiving an acknowledgement of the mobility completion message from Cell 1. The second information could indicate beam information (e.g., Transmission Configuration Indicator (TCI) state information such as TCI states id or spatial relation info) associated with target Cell (e.g., Cell 1) to the UE. The UE could activate (Downlink (DL)) TCI states or beams associated with the Cell 1 to receive the UL grant from Cell 1.

With the mobility procedure, the UE could perform L1/L2 mobility (e.g., a handover-like procedure) to switch its serving cell to other Cells without overhead caused by exchanging RRC message. However, based on different ways of performing the mobility procedures, different exceptional situation could occur and cause such mobility procedures not successfully completed (in time). This invention introduces methods for handling exceptional situation or error associated with L1/L2 mobility procedures. The L1/L2 mobility procedures could contain performing a random access procedure to the target Cell.

A concept of the invention is that a UE could perform (a part of) one or more actions for failure handling of a mobility procedure. The UE could determine which of the one or more actions to perform based on at least failure cause of the mobility procedure.

### Notification to Original Serving Cell, e.g., Confirmation or Error Report

The one or more actions could include a UE transmitting a signaling to a Source Cell. The mobility procedure could be initiated for the UE to switch its Primary Cell (or Special Cell) from the Source Cell to the target Cell. Additionally and/or alternatively, the mobility procedure could be initiated for the UE to add one or more Secondary Cells/release its current (active or configured) Secondary Cell(s). The signaling could be a report indicating the failure of the mobility procedure (or indicating the UE determines to perform failure handling) to the Source Cell (or to the gNB of the Source Cell). The signaling could indicate an (positive or negative) acknowledgement of the second information. The signaling could contain mobility procedure failure information. The signaling could include or indicate failure cause of the mobility procedure (e.g., timer expiry, random access procedure unsuccessful, Scheduling Request (SR) maximum transmission number reached, etc). The signaling could indicate identity of the target Cell or beam(s) used for the mobility procedure. The Source Cell, in response to receiving the signaling, could indicate another mobility procedure (via transmitting another second information) to the UE. The signaling could be a MAC CE or RRC message.

### Initiation of RA Procedure (to Target Cell or Source Cell) or BFR

Additionally and/or alternatively, the one or more actions could include the UE performing a (fallback) random access procedure to the target Cell. The random access procedure could be a contention-based random access procedure. Alternatively, the random access procedure could be a contention-free random access procedure. The configuration and/or resource(s) associated with the random access procedure could be provided in the first and/or second information. Alternatively, the first or second information may not provide or indicate resource(s) for (fallback) random access procedure. The one or more actions may not include performing a (RRC) connection (re-)establishment procedure. Alternatively, the UE could perform a (RRC) connection (re-)establishment procedure to the target Cell in response to performing the one or more actions. Additionally and/or alternatively, the one or more actions could be the UE switching (from contention-free random access procedure) to contention-based random access procedure to the target Cell. Additionally and/or alternatively, the UE could perform a random access procedure to the target Cell on an initial or default Bandwidth Part (BWP).

Additionally and/or alternatively, the one or more actions could include the UE stopping a (current) random access procedure (to the target Cell).

Additionally and/or alternatively, the one or more actions could include the UE cancelling a triggered SR (associated with the target Cell).

Additionally and/or alternatively, the one or more actions could include the UE discarding a (configured) UL grant (on the target Cell). The UL grant could be provided/scheduled by the source Cell. The UL grant could be used to transmit the mobility completion message.

Additionally and/or alternatively, the one or more actions could include the UE performing a (fallback) random access procedure to the source Cell. The UE could revert back to configuration(s) associated with the source Cell. Before initiating a mobility procedure to the target Cell, the UE could store the configuration(s) associated with the source Cell. The UE could perform a connection re-establishment procedure to gNB associated with the source Cell in response to failure of the mobility procedure to the target Cell.

Additionally and/or alternatively, the one or more actions could include the UE switching (from contention-free random access procedure) to contention-based random access procedure to the source Cell. Additionally and/or alternatively, the UE could perform a random access procedure to the source Cell on an initial or default BWP.

Additionally and/or alternatively, the one or more actions could include the UE initiating or performing a beam failure recovery procedure to the target Cell. The beam failure recovery procedure could contain providing, to the target Cell, candidate beam(s) for DL and/or UL communication with the target Cell (e.g., via a MAC CE).

Additionally and/or alternatively, the one or more actions could include the UE initiating or performing a beam failure recovery procedure to the source Cell. The beam failure recovery procedure could contain providing, to the target Cell, candidate beam(s) for DL and/or UL communication with the target Cell (e.g., via a MAC CE).

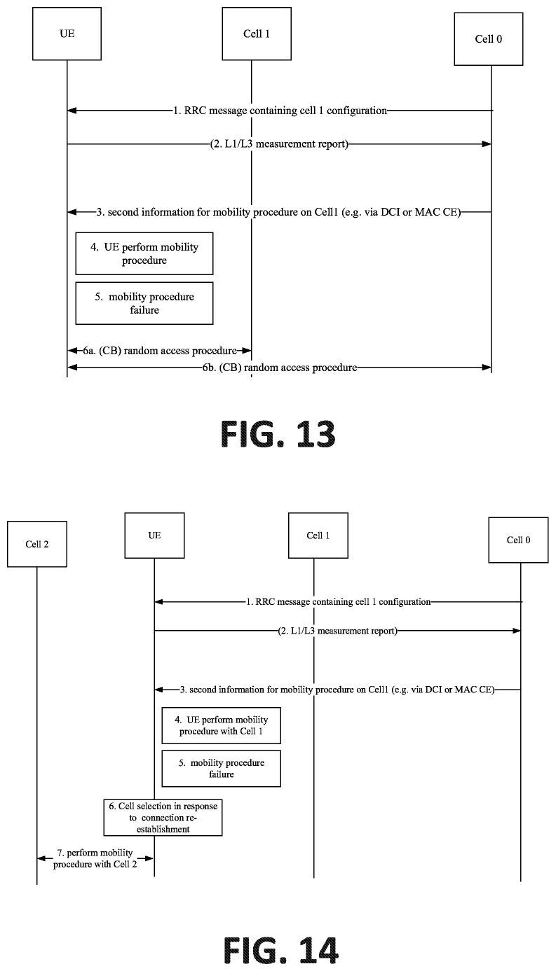

An example is shown in FIG. 13, further based on FIG. 9. The UE performs mobility procedure to Cell 1. To perform failure handling of the mobility procedure, the UE could perform either step 6a) a (contention-based) random access procedure to Cell 1, or step 6b) a (contention-based) random access procedure to Cell 0.

### RRC Connection Re-Establishment

### Candidate Cells are Prioritized to be Selected

Additionally and/or alternatively, the one or more actions could include the UE initiating or performing a RRC connection re-establishment procedure. The UE could revert back to (RRC) configuration(s) associated with the source Cell. The UE could reset MAC in response to the failure of the mobility procedure and/or in response to the initiation of the RRC connection re-establishment.

The UE could perform cell selection in response to the initiation of the RRC connection re-establishment. The UE could select a Cell in response to the initiation of the RRC connection re-establishment. The UE could prioritize a first Cell (among one or more suitable Cells) in Cell selection if or when the first Cell is indicated in the first or second information. The UE could prioritize the first Cell (among one or more suitable Cells) during the RRC connection re-establishment if or when the first Cell is indicated in the first or second information. The UE could prioritize the first Cell by selecting the first Cell (instead of selecting other suitable Cells that are not indicate in the first or second information). Additionally and/or alternatively, the UE could prioritize the source Cell or Cells associated with gNB of the Source Cell (among the one or more suitable Cells) in Cell selection. Additionally and/or alternatively, the UE could prioritize the target Cell or Cells associated with gNB of the target Cell (among the one or more suitable Cells) in Cell selection.

An example is shown in FIG. 14, further based on FIG. 9. The UE first performs mobility procedure with Cell 1 (indicated by second information from Cell 0). In response to failure of the mobility procedure, the UE could perform connection re-establishment. In response to the connection re-establishment, the UE performs cell (re)selection and selects Cell 2 as a new target Cell. Preferably, the UE prioritizes Cells (e.g., Cell 2) indicated in the first information (with or without considering Cell 1) when selecting a suitable Cell for connection re-establishment.

### TA Invalidation, L2 Reset, or Etc.

Additionally and/or alternatively, the one or more actions could include the UE could considering a time alignment information associated with the target Cell to be invalid. For example, the UE could consider timeAlignmentTimer(s) associated with the target Cell as expired. For another example, the UE could stop timeAlignmentTimer(s) associated with the target Cell. The time alignment information could be provided by or derived from the first or the second information. The UE could initiate a random access procedure to the target Cell to obtain a new time alignment information.

Additionally and/or alternatively, the one or more actions could include the UE performing (part of) MAC reset of a MAC entity associated with the target Cell in response to failure of the mobility procedure. For example, the UE could cancel, if any, triggered SR and/or Buffer Status Reporting (BSR) procedure in response to failure of the mobility procedure. Additionally and/or alternatively, the UE could cancel, if any, triggered Beam Failure Recovery (BFR). Additionally and/or alternatively, the UE could flush Msg3 and/or MsgA and/or soft buffers for all DL Hybrid Automatic Repeat Request (HARQ) process. Additionally and/or alternatively, the UE could stop (all) running timers. Additionally and/or alternatively, the UE could consider timeAlignmentTimers as expired.

### Trigger SR as Failure Handling

Additionally and/or alternatively, the one or more actions could include the UE triggering a SR.

Additionally and/or alternatively, the one or more actions could include the UE switching an active (DL and/or UL) BWP of the target Cell to an (DL and/or UL) initial BWP or default BWP.

When the UE determines to perform failure handling of the mobility procedure, the UE could determine that the mobility procedure has failed or a failure of the mobility procedure has occurred.

Cases where a UE could Perform Failure Handling of a Mobility Procedure

### Random Access Procedure not Successfully Completed

The failure of the mobility procedure could be in response to a failure of a random access procedure to the target Cell. Additionally and/or alternatively, the UE could consider a mobility procedure as failed if or when a random access procedure is not successfully completed.

The UE could determine whether to perform failure handling of the mobility procedure based on whether a random access procedure associated with the mobility procedure is successfully completed. The UE could perform failure handling of the mobility procedure when the random access procedure is not successfully completed.

No Acknowledgement or UL Grant from the Target Cell

The UE could determine whether to perform failure handling of the mobility procedure based on a signaling (from a target Cell) is received or not in a period of time. The signaling could be an acknowledgement from the target Cell (in response to a mobility completion message). Additionally and/or alternatively, the signaling could be an UL grant (for the UE to transmit the mobility completion message). Additionally and/or alternatively, the signaling could be a MAC CE (e.g., Cell Radio Network Temporary Identifier (C-RNTI) MAC CE) or a L1 signal. The UE could consider the mobility procedure to be (successfully) completed if or when the signaling is received (in the period of time) (from the target Cell). The UE could determine the period of time based on a timer.

The UE could start the period of time (e.g., consider the starting point of the period of time at) in response to or upon transmission of a mobility completion message to the target Cell or in response to receiving the second information or in response to receiving an UL grant for transmitting the mobility completion message. The UE could stop the period of time (e.g., stop the timer) in response to receiving the signaling. The UE could restart the period of time (e.g., restart the timer) in response to receiving an UL grant (e.g., for retransmission of the mobility completion message from the target Cell).

The active time (for Discontinuous Reception (DRX) group including the target Cell) of the UE could include the time while the mobility completion message is sent and before receiving the signaling (from the target Cell). Additionally and/or alternatively, the active time (for DRX group including the target Cell) of the UE could include the time while the second information is received and before receiving the signaling (from the target Cell).

The UE could monitor Physical Downlink Control Channel (PDCCH) of the target Cell after the transmission of the mobility completion message. The UE could transmit the mobility completion message via UL grant and/or beam(s) indicated via the first and/or the second information. The UE could monitor PDCCH of the target Cell via TCI states or beam(s) indicated in the first and/or the second information. The UE could consider the mobility procedure to be failed if or when the signaling is not received (from the target Cell) before expiry of the timer or before the end of the period of time.

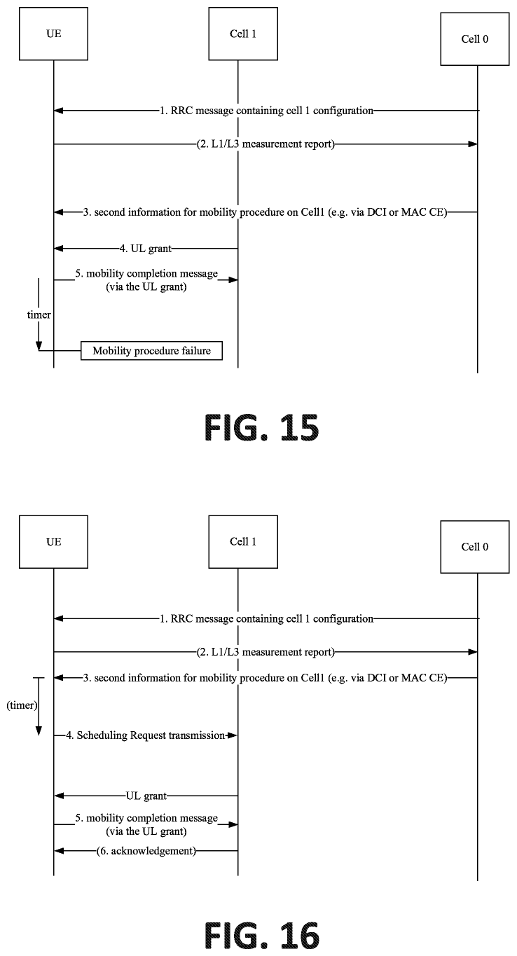

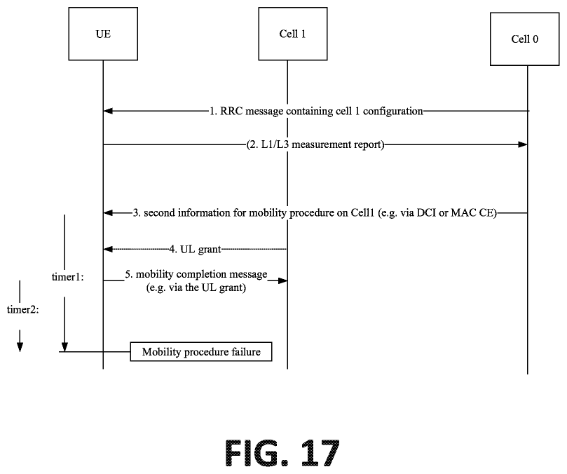

An example is shown in FIG. 15. The UE receives a second information indicating mobility procedure to Cell 1 from Cell 0 and a UL grant from Cell 0 (could be received in the second information). The UE could transmit a mobility completion message and start a timer in response to the transmission. Upon timer expiry, if the UE does not receive acknowledgment or DL signaling from the Cell 1, the UE could consider the mobility procedure fails. The UE could report to Cell 0 regarding the failure and/or perform a random access procedure on Cell 1 and/or consider the TA information (provided by first or second information) of the Cell 1 as invalid.

### Handling of not Receiving ACK

### Auto Retransmission, e.g., Timer Control, Power Ramping, Maximum Retransmission

Additionally and/or alternatively, the UE could perform one or more retransmissions of the mobility completion message to the target Cell. The UE could (re)start the timer or the period of time in response to each (re)transmission of the mobility completion message. UL resource(s) for transmitting (re)transmission of the mobility completion message could be provided or indicated in the first or second information. Additionally and/or alternatively, UL resource(s) for transmitting (re)transmission of the mobility completion message could be provided or indicated by the target Cell (e.g., Cell 1).

Additionally and/or alternatively, the UE could perform one or more retransmissions of the mobility completion message to the target Cell. The UE could perform retransmission of the mobility completion message in response to expiry of a retransmission timer. The retransmission timer could be provided by the first and/or the second information. The UE could start the retransmission timer in response to (re)transmission of the mobility completion message. The UE could stop the retransmission timer in response to reception of the signaling from the target Cell.

Additionally and/or alternatively, the UE could increment power used to transmit the mobility completion message (for each retransmission). An initial transmission power could be provided in the first or second information. A power ramping step could be provided in the first or the second information. The UE could increase the transmission power by one power ramping step, compared to the previous (re)transmission of the mobility completion message, for each retransmission of the mobility completion message.

Additionally and/or alternatively, the UE could determine to perform failure handling of the mobility procedure based on a maximum number of (re)transmission for the mobility completion message being reached. Additionally and/or alternatively, the UE could perform failure handling of the mobility procedure when a maximum number of (re)transmission is reached for the mobility completion message and the timer expires.

### UL Grant Provided by Source Cell is not Available

Additionally and/or alternatively, the UE could perform failure handling of the mobility procedure if or when quality of (all) reference signal(s) associated with a UL grant is lower than a threshold. The UL grant could be provided or indicated by the source Cell (e.g., via a first and/or a second information). Alternatively, the UL grant could be provided or indicated by the target Cell. The reference signal(s) (e.g., SSB or CSI-RS) could be provided or indicated by the source Cell (e.g., via a first and/or a second information). The reference signal(s) could be associated with (DL) beam(s) for receiving the UL grant. Alternatively, the reference signal(s) could be associated with (UL) beam(s) for transmission using the UL grant. The UL grant could be used to transmit the mobility completion message to the target Cell. The UE could determine/check the quality of the reference signal(s) when or before (re)transmitting the mobility completion message via the UL grant.

### UL Grant not Provided by the Target Cell

The UE could determine whether to perform failure handling of the mobility procedure based on a signaling (from a target Cell) is received or not in a period of time. The signaling could be an UL grant (for transmitting mobility completion message).

### Trigger a SR for UL Grant

Additionally and/or alternatively, the UE could trigger a SR associated with the target Cell if or when a gNB of the target Cell does not schedule or provide a UL grant. The UE could trigger a SR associated with the target Cell if or when the UE does not receive a UL grant from a gNB of the target Cell during a period of time after the UE receives the second information (from the Source Cell). Configuration of the SR could be configured by the source Cell of the UE (e.g., via first information). Additionally and/or alternatively, the second information could indicate which SR configuration to use for mobility procedure for the target Cell (e.g., via a configuration id).

Additionally and/or alternatively, the UE could trigger a SR in response to expiry of a timer. The UE could start the timer in response to receiving a second information (from a source Cell) initiating a mobility procedure. There may not be a pending (regular) BSR of the UE when the SR is triggered. The UE could stop the timer in response to receiving a signaling from the target Cell (e.g., receiving a signaling indicating an UL grant). An example is shown in FIG. 16, for a mobility procedure for a UE to switch Primary Cell from Cell 0 to Cell 1. The UE could start a timer in response to receiving a second information from Cell 0 for mobility procedure. The UE does not receive an UL grant from Cell 1 or Cell 0 when the timer is running. In response to expiry of the timer (and has not yet receive a UL grant from Cell 1), the UE could trigger a SR associated with Cell 1. The UE could perform one or more SR transmissions to Cell 1. The Cell 1 could provide or schedule a UL grant for the UE to transmit a mobility completion message in response to the one or more SR transmissions.

Alternatively, the UE could trigger a SR in response to receiving the second information (e.g., without waiting for expiry of a timer). The UE could transmit SR transmission to target Cell (e.g., Cell 1 in FIG. 13) in response to receiving the second information. Resources for the SR transmission could be provided or indicated in the first and/or second information. The first and/or second information could provide Physical Uplink Control Channel (PUCCH) resource and/or UL beam information for SR transmission.

Another example is shown in FIG. 17. The UE could start a timer in response to receiving the second information initiating the mobility procedure, or the UE could start the timer in response to transmission of a mobility completion message. The mobility completion message could be generated or transmitted in response to the second information. The UE could receive or be scheduled or be configured with a UL grant (by network of Cell 0 or Cell 1) for transmitting the mobility completion message. The UE could consider the mobility procedure to be failed (or determine a failure) based on the timer expiry.

Failure when Maximum SR Reached

Additionally and/or alternatively, the UE could perform failure handling of the mobility procedure if or when a maximum number of SR transmission has reached. The UE could consider the mobility procedure failed if or when a number of SR transmissions to the target Cell is larger than or equal to a maximum value (e.g., sr-TransMax).

Consider BFD from the Target Cell as UL Grant Cannot be Received

Additionally and/or alternatively, the UE could perform failure handling of the mobility procedure if or when beam failure is detected or a BFR is triggered on the target Cell before completion of the mobility procedure. The beam failure could be detected associated with beam(s) indicated by first or second information. Beam failure configuration (e.g., BeamFailureRecoveryConfig, BeamFailureRecoverySCellConfig, and the RadioLinkMonitoringConfig) could be provided by the first information.

Mobility Procedure to Target Cell has not been Completed after a Time Period

The UE could determine whether to perform failure handling of the mobility procedure based on status of a (RRC) timer. The UE could perform failure handling of the mobility procedure upon expiry of the timer. The UE could start the timer in response to receiving the second information or in response to initiating the mobility procedure or in response to (re)transmission of a mobility completion message. The UE could stop the timer in response to completion of the mobility procedure.

For any of the examples, teachings, and concepts taught above and herein, the following examples, teachings, and concepts can be applied or implemented, in whole or in part.

A mobility procedure could be used to add, release or switch one or more of the UE's Secondary Cells. The mobility procedure may not add, release or switch PCell and/or PSCell of the UE. The mobility procedure could be triggered by a second information.

Additionally and/or alternatively, a mobility procedure could contain that the UE triggers and/or generates a message (and transmits) to a target cell (PCell, PSCell, neighbouring Cell or a SCell). The mobility procedure could contain the UE initiate a (contention-free) random access procedure on the target cell. The random access procedure could be initiated in response to the message becoming available for transmission. The message could indicate a completion of the mobility procedure. The mobility procedure could be used to switch the UE's Primary Cell (or Primary Secondary Cell) to the target cell. The UE could consider the mobility procedure to be completed in response to a completion of the random access procedure. The UE could consider the mobility procedure to be completed in response to receiving a positive acknowledgement associated with the message (from the target cell). The UE could initiate a random access procedure or transmits a preamble on Cell(s) via one or more beams associated with the Cell(s) indicated in the second information. The mobility procedure could contain the UE switch its SpCell to a target Cell and/or add/release one or more secondary Cells associated with one or more CGs.

A (L1/L2) mobility procedure could contain a serving cell providing first information to a UE indicating/providing configuration associated with at least a target cell. The first information could provide configuration associated with one or more Cells or one or more CGs. The configuration could contain cell addition information and/or beam information associated with the target cell. The first information could be a dedicated signaling to the UE. The source cell could provide second information to the UE indicating initiation of a mobility procedure to the target cell. The procedure could contain a random access procedure and/or one or more Physical Uplink Shared Channel (PUSCH) transmissions and/or beam (TCI state) activation. The second information does not contain RRC signaling and/or RRC messages. The second information could be a L1 (e.g., Downlink control information) or a L2 (e.g., MAC CE) message. The first information and the second information could be transmitted in different signaling and/or timings. The UE does not initiate the mobility procedure to the target cell in response to (reception of) the first information. The UE could transmit a mobility completion message to the target cell indicating a completion of the procedure. Additionally and/or alternatively, the target cell could transmit an acknowledgement to the UE indicating completion of the procedure. An example is shown in FIG. 12. The UE could consider the mobility procedure to be completed in response to acknowledgement from the target cell. Alternatively, the UE could consider the mobility procedure to be complete in response to transmission of the mobility completion message. Alternatively, the UE could consider the mobility procedure to be complete in response to completion of a random access procedure (associated with the mobility procedure).

The first information could contain time alignment (TA) information associated with the target Cell and/or the one or more Cells (and the second information does not contain the TA information). Additionally and/or alternatively, the second information could contain time alignment (TA) information associated with the target Cell and/or the one or more Cells (and the first information does not contain the TA information). In response to initiating or completion of a mobility procedure associated with the target Cell, the UE could apply the TA information of the target Cell. The TA information could be a N_{TA} or timing difference between uplink and downlink associated with a Cell (e.g., target Cell). Additionally and/or alternatively, the TA information could include a Timing Advance Command or a TAG id for a TA group associated with a Cell (e.g., target Cell).

The first information could contain beam (e.g., DL/UL TCI state id or spatial relation info) information associated with at least a target Cell and/or one or more Cells. Additionally and/or alternatively, the second information could contain or indicate beam information associated with at least the target Cell and/or one or more Cells. For one example, the first information could indicate a list of beams for a target Cell, and the second information could indicate one beam in the list of beams for the target Cell, and the UE uses the one beam indicated in the second information for mobility procedure to the target Cell. Alternatively, the first information may not contain beam information (and the second information contains beam information). The UE could transmit mobility completion message to the target Cell via beam(s) indicated in the first or second information associated with the target Cell. The UE could activate beam(s) or TCI state(s) indicated in the second information in response to receiving the second information or in response to initiating the mobility procedure. The second information could indicate a BWP (e.g., a BWP id) of the target Cell on which the UE performs a mobility procedure.

The mobility procedure could contain part of handover procedure or reconfiguration with sync procedure.

A completion of a mobility procedure could be a completion of a random access procedure associated with the mobility procedure. Alternatively, the completion of the mobility procedure could be a transmission of a mobility completion message (to the target cell). Alternatively, the completion of the mobility procedure could be a reception of an acknowledgement of the mobility completion message (from the target cell).

The mobility procedure is not a reconfiguration with sync (e.g., not a Layer-3 handover).

The first information could be a RRC message (e.g., a RRCReconfiguration message).

The first information could contain UL and/or DL resource configuration associated with the target cell (and/or one or more Cells to be added as SCell when initiating or completing the mobility procedure).

The first information could contain ServingCellConfigCommon of the target cell and the one or more Cells. The one or more Cells could be candidate Serving Cells for MCG or SCG of the UE.

The second information is not a RRC message/signaling. The second information could contain a PDCCH signaling (e.g., DCI) and/or MAC CE. The second information could indicate the UE to initiate a mobility procedure adding/activating (a part of) the one or more Cells. Alternatively, the second information could indicate the UE to adding/activating (a part of) the one or more Cells (as Secondary Cells or as Primary Cells). The second information could indicate Cells (e.g., via an index indicated in the first information or a SCell index) to be added/switched/released (via a mobility procedure). In response to (completion of) adding/activating the (a part of) one or more Cells, the UE could consider the (a part of) one or more Cells as Serving Cells.

The first information could contain configurations of one or more Cells or CGs. The second information could at least indicate at least one of the one or more Cells or CGs to the UE. The second information may not contain or indicate the configurations of the one or more Cells or CGs. The second information could indicate the UE to initiate a mobility procedure (associated with the one or more Cells or CGs). The second information could indicate the UE to add/activate at least one of one or more Cells (as Serving Cells). Each Cell of the one or more Cells could be associated with a Cell group (MCG or SCG). The UE could initiate a mobility procedure in response to receiving the second information. The UE may not initiate the mobility procedure in response to receiving the first information. Additionally and/or alternatively, the UE could consider at least one of the one or more Cells to be a Serving Cell (e.g., the Serving Cell could be a PCell, a SCell, or a PSCell) of the UE in response to a completion of the mobility procedure initiated in response to receiving the second information. The UE does not consider the at least one of the one or more Cells to be a Serving Cell of the UE in response to receiving the first information. Additionally and/or alternatively, the one or more Cells could comprise Cell(s) associated with Physical Cell id(s) (PCI)(s) different from Serving Cell(s) of the UE before receiving the first and/or the second information. Additionally and/or alternatively, the one or more Cells could comprise Cell(s) associated with physical cell id (PCI)(s) different from Serving Cell(s) of the UE before receiving the first and/or the second information.

The first information and the second information could be transmitted in different signalings.

The first information and the second information could be transmitted at different timings.

The configurations could include serving cell configuration.

The one or more Cells or CGs could contain Serving Cell(s) and/or non-serving Cell(s)

The second information may not be SCell Activation/Deactivation MAC CE.

The second information may not indicate ServCellIndex or physcellid of the one or more Cells. The second information could indicate Cell Group (e.g., MCG or SCG) associated with the one or more beams and/or Cells.

The mobility procedure could contain part of handover procedure or reconfiguration with sync procedure.

The mobility procedure could comprise the UE transmitting UL data or control information to the target cell. The UL data could contain information associated with the UE (e.g., C-RNTI MAC CE). The UL data could be transmitted via PUSCH. The UL control information could be transmitted via PUCCH.

The message could be a mobility completion message. The mobility completion message may not contain a RRC message. The mobility completion message could contain a MAC CE. The mobility completion message could be a PUCCH or PUSCH transmission.

The one or more Cells may not be a Primary Cell (PCell) or a target Cell. The second information could indicate both a target Cell and additionally the one or more Cells (e.g., via the Cell information) to the UE, where the UE initiates a mobility procedure and consider the target Cell as PCell in response to completion (or initiation) of the mobility procedure.

To add a (candidate Serving) Cell, the UE adds the Cell as SCell (or PCell) and apply the Cell's configuration. The Cell's configuration could be indicated in the first information (e.g., parameters in sCellConfigCommon and sCellConfigDedicated).

The index or id (provided or indicated in the first information) may not be ServCellIndex. The index or id may not be sCellIndex.

The Cell information (in the second information) could indicate one or more Cells to be added (in a MCG and/or SCG) in response to receiving the second information.

A beam could be associated with a spatial relation info or associated with a TCI state. A TCI state could be associated with PDCCH monitoring (on a Control Resource Set (CORESET) of a Cell). A TCI state could be associated with Physical Downlink Shared Channel (PDSCH) reception (on a Cell). A spatial relation info could be associated with PUCCH/PUSCH transmission.

The one or more beams (indicated in first or second information) could be associated with TCI states for PDCCH, PDSCH monitoring. The one or more beams (indicated in first or second information) could be associated with spatial relation info for SRS, CSI-RS, PUCCH, or PUSCH transmission.

A current or existing Cell could be a Cell configured/activated/added before receiving the second information or before initiating the mobility procedure. The current or existing Cell could be a Secondary Cell (or a PCell). The current or existing Cell could be indicated in the first or second information. The UE may not remove/deactivate/release the current or existing Cell (in response to receiving the second information or in response to initiating or completing the mobility procedure) if or when the Cell is indicated in the second information.

The group of beam(s) could contain (only) a single beam. Alternatively, the group of beam(s) could contain more than one beam.

The one or more beams could be indicated via reference signals or TCI state(s). Each of the one or more sets could be associated or be indicated with one or more reference signals (e.g., Synchronization Signal Block (SSB) or Channel State Information Reference Signal (CSI-RS)). The one or more beams could be SSB or CSI-RS. Each of the one or more beams could be associated with (DL or UL) TCI state(s) (e.g., indicated via TCI-stateId) and/or spatial relation info (e.g., spatial relation info ID). The one or more beams could be used to monitor/receive DL transmission from Cell(s) in the one or more Cells when activating/adding the Cell(s) in a mobility procedure or when receiving a second information. Additionally and/or alternatively, the one or more beams could be associated with spatial relation info (e.g., via spatial relation info ID in the first information).

For a UE performing inter-Cell multi-transmission/reception point (mTRP) operation, the UE could perform DL and/or UL transmissions via more than one PDCCH, PDSCH, PUCCH, PUSCH associated with different Cells. The DL and/or UL transmissions could contain transmitting a same TB on different channels associated with (different TRPs of) different Cells. The UE could perform multi-PDCCH/PUSCH/PDSCH/PUCCH communication with a network via a TRP on a Serving Cell and another TRP on a non-serving Cell (e.g., an assist Cell or an additional Cell) associated with the Serving Cell. The Serving Cell could be configured (for the UE) with one or more non-serving Cells for inter-Cell mTRP operation.

The signaling or the acknowledgment from the target Cell could be a UL grant (for a new transmission). The UL grant could be for a HARQ process used for the transmission of a mobility completion message. The UE could consider a mobility procedure to be completed in response to receiving the signaling or the acknowledgement.

For second information indicating different Logical Channel ID(s) (LCIDs), the second information could be different MAC CEs.

The source Cell of the UE could be a Serving Cell (or PCell) before receiving the second information. Additionally and/or alternatively, the source Cell of the UE could be a Serving Cell providing the second information.

The target Cell of the UE could be a new Serving Cell (or new PCell) added in response to the mobility procedure.

The time alignment information could include timing difference between uplink and downlink (e.g., N_{TA}).

The UE could perform failure handling of the mobility procedure in response to a failure of the mobility procedure. When the UE performs a failure handling of the mobility procedure, the UE could consider the mobility procedure to be failed.

All concepts, examples, and embodiments above and herein could be combined into one or more new concept, examples, and embodiments, in whole or in part.

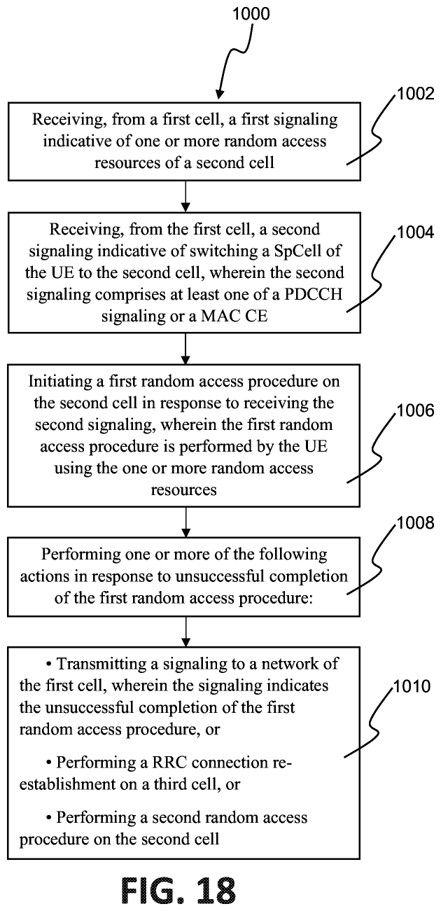

Referring to FIG. 18, with this and other concepts, systems, and methods of the present invention, a method 1000 for a UE in a wireless communication system comprises receiving, from a first cell, a first signaling indicative of one or more random access resources of a second cell (step 1002), receiving, from the first cell, a second signaling indicative of switching a SpCell of the UE to the second cell, wherein the second signaling comprises at least one of a PDCCH signaling or a MAC CE (step 1004), initiating a first random access procedure on the second cell in response to receiving the second signaling, wherein the first random access procedure is performed by the UE using the one or more random access resources (step 1006), and performing one or more actions in response to unsuccessful completion of the first random access procedure (step 1008), including: transmitting a signaling to a network of the first cell, wherein the signaling indicates the unsuccessful completion of the first random access procedure, performing a RRC connection re-establishment on a third cell, or performing a second random access procedure on the second cell (step 1010).

In various embodiments, the first signaling comprises a RRC message.

In various embodiments, the first random access procedure is a contention-free random access procedure.

In various embodiments, the third cell is the same as the first cell, or the third cell is the same as the second cell.

In various embodiments, the third cell is a fourth cell indicated in the first signaling.

In various embodiments, the UE prioritize the fourth cell over a fifth cell for the RRC connection re-establishment based on the fourth cell being indicated in the first signaling, wherein the fifth cell is not indicated in the first signaling.

In various embodiments, the first signaling is indicative of at least one of a cell configuration of the second cell, an identity associated with the second cell, an index associated with the second cell or a Cell Radio Network Temporary Identifier (C-RNTI), for the UE, for the second cell.

In various embodiments, the second information indicates the UE to add the first Cell as a Secondary Cell.

Referring back to FIGS. 3 and 4, in one or more embodiments from the perspective of a UE, the device 300 includes a program code 312 stored in memory 310 of the transmitter. The CPU 308 could execute program code 312 to: (i) receive, from a first cell, a first signaling indicative of one or more random access resources of a second cell; (ii) receive, from the first cell, a second signaling indicative of switching a SpCell of the UE to the second cell, wherein the second signaling comprises at least one of a PDCCH signaling or a MAC CE; (iii) initiate a first random access procedure on the second cell in response to receiving the second signaling, wherein the first random access procedure is performed by the UE using the one or more random access resources; (iv) perform one or more actions in response to unsuccessful completion of the first random access procedure, including: (v) transmit a signaling to a network of the first cell, wherein the signaling indicates the unsuccessful completion of the first random access procedure, perform a RRC connection re-establishment on a third cell, or perform a second random access procedure on the second cell. Moreover, the CPU 308 can execute the program code 312 to perform all of the described actions, steps, and methods described above, below, or otherwise herein.

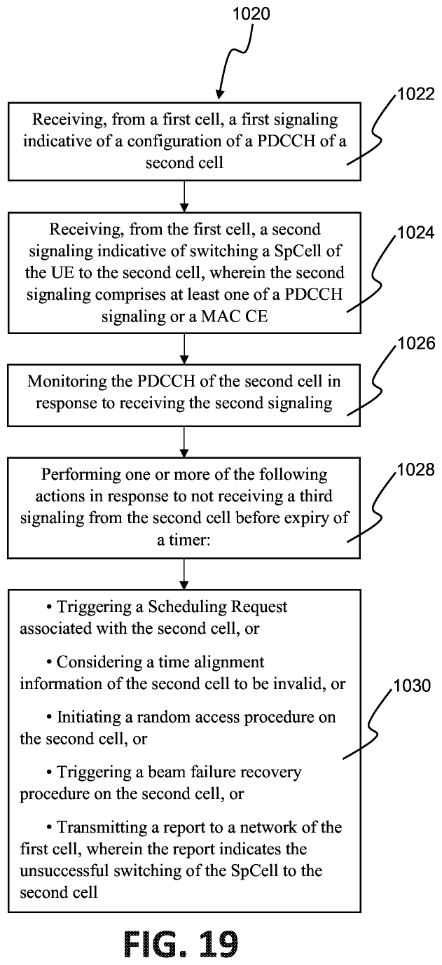

Referring to FIG. 19, with this and other concepts, systems, and methods of the present invention, a method 1020 for a UE in a wireless communication system comprises receiving, from a first cell, a first signaling indicative of a configuration of a PDCCH of a second cell (1022), receiving, from the first cell, a second signaling indicative of switching a SpCell of the UE to the second cell, wherein the second signaling comprises at least one of a PDCCH signaling or a MAC CE (step 1024), monitoring the PDCCH of the second cell in response to receiving the second signaling (step 1026), and performing one or more actions in response to not receiving a third signaling from the second cell before expiry of a timer (1028), including: triggering a Scheduling Request associated with the second cell, considering a time alignment information of the second cell to be invalid, initiating a random access procedure on the second cell, triggering a beam failure recovery procedure on the second cell, or transmitting a report to a network of the first cell, wherein the report indicates the unsuccessful switching of the SpCell to the second cell (step 1030).

In various embodiments, the first signaling is a RRC message.

In various embodiments, the UE starts the timer in response to receiving the second signaling.

In various embodiments, the first signaling is indicative of at least one of a cell configuration of the second cell, an identity associated with the second cell, a time alignment information associated with the second cell, or a SR configuration associated with the second cell.

In various embodiments, the UE performs one or more SR transmissions on the second Cell in response to a triggered SR associated with the second cell.

In various embodiments, the UE initiates a random access procedure on the second Cell in response to the number of performed one or more SR transmissions is larger than or equal to a maximum transmission number.

In various embodiments, the time alignment information is a timing difference between uplink and downlink of the second cell.

In various embodiments, the beam failure recovery procedure includes transmitting a MAC CE to the second cell indicating candidate beam(s) for DL and/or UL transmission with the second cell.

In various embodiments, the third signaling is a UL grant for the UE to perform transmission to the second cell.

Referring back to FIGS. 3 and 4, in one or more embodiments from the perspective of a UE, the device 300 includes a program code 312 stored in memory 310 of the transmitter. The CPU 308 could execute program code 312 to: (i) receive, from a first cell, a first signaling indicative of a configuration of a PDCCH of a second cell; (ii) receive, from the first cell, a second signaling indicative of switching a SpCell of the UE to the second cell, wherein the second signaling comprises at least one of a PDCCH signaling or a MAC CE; (iii) monitor the PDCCH of the second cell in response to receiving the second signaling; (iv) perform one or more actions in response to not receiving a third signaling from the second cell before expiry of a timer, including: (v) trigger a Scheduling Request associated with the second cell, considering a time alignment information of the second cell to be invalid, initiating a random access procedure on the second cell, trigger a beam failure recovery procedure on the second cell, or transmit a report to a network of the first cell, wherein the report indicates the unsuccessful switching of the SpCell to the second cell. Moreover, the CPU 308 can execute the program code 312 to perform all of the described actions, steps, and methods described above, below, or otherwise herein.

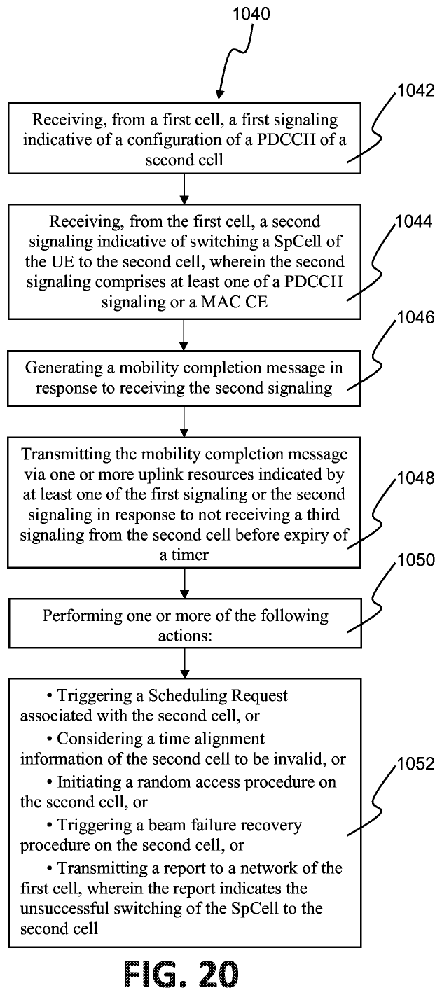

Referring to FIG. 20, with this and other concepts, systems, and methods of the present invention, a method 1040 for a UE in a wireless communication system comprises receiving, from a first cell, a first signaling indicative of a configuration of a PDCCH of a second cell (step 1042), receiving, from the first cell, a second signaling indicative of switching a SpCell of the UE to the second cell, wherein the second signaling comprises at least one of a PDCCH signaling or a MAC CE (step 1044), generating a mobility completion message in response to receiving the second signaling (step 1046), transmitting the mobility completion message via one or more uplink resources indicated by at least one of the first signaling or the second signaling in response to not receiving a third signaling from the second cell before expiry of a timer (step 1048), performing one or more actions (step 1050), including: triggering a Scheduling Request associated with the second cell, considering a time alignment information of the second cell to be invalid, initiating a random access procedure on the second cell, triggering a beam failure recovery procedure on the second cell, or transmitting a report to a network of the first cell, wherein the report indicates the unsuccessful switching of the SpCell to the second cell (step 1052).

In various embodiments, the third signaling is an acknowledgement from the second cell.

In various embodiments, the second signaling is a PDCCH signaling or a MAC control element.

In various embodiments, the first signaling is a RRC message.

In various embodiments, the id or index is serving cell index or physical cell id.

Referring back to FIGS. 3 and 4, in one or more embodiments from the perspective of a UE, the device 300 includes a program code 312 stored in memory 310 of the transmitter. The CPU 308 could execute program code 312 to: (i) receive, from a first cell, a first signaling indicative of a configuration of a PDCCH of a second cell; (ii) receive, from the first cell, a second signaling indicative of switching a SpCell of the UE to the second cell, wherein the second signaling comprises at least one of a PDCCH signaling or a MAC CE; (iii) generate a mobility completion message in response to receiving the second signaling; (iv) transmit the mobility completion message via one or more uplink resources indicated by at least one of the first signaling or the second signaling in response to not receiving a third signaling from the second cell before expiry of a timer; (v) perform one or more actions, including: (vi) trigger a Scheduling Request associated with the second cell, consider a time alignment information of the second cell to be invalid, initiate a random access procedure on the second cell, trigger a beam failure recovery procedure on the second cell, or transmit a report to a network of the first cell, wherein the report indicates the unsuccessful switching of the SpCell to the second cell. Moreover, the CPU 308 can execute the program code 312 to perform all of the described actions, steps, and methods described above, below, or otherwise herein.

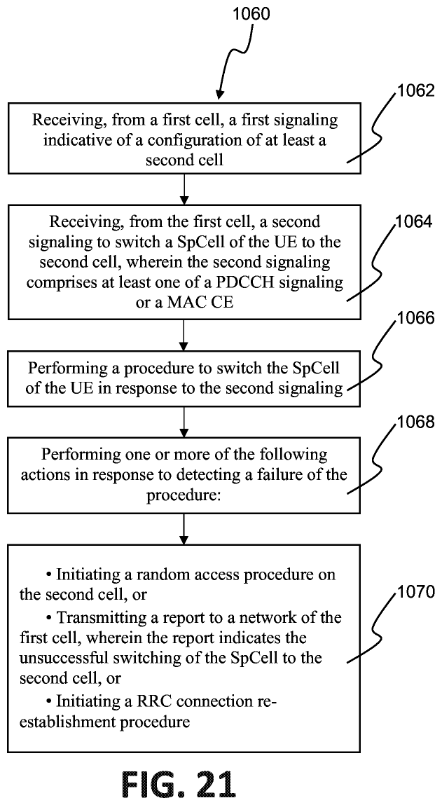

Referring to FIG. 21, with this and other concepts, systems, and methods of the present invention, a method 1060 for a UE in a wireless communication system comprises receiving, from a first cell, a first signaling indicative of a configuration of at least a second cell (step 1062), receiving, from the first cell, a second signaling to switch a SpCell of the UE to the second cell, wherein the second signaling comprises at least one of a PDCCH signaling or a MAC CE (step 1064), performing a procedure to switch the SpCell of the UE in response to the second signaling (step 1066), performing one or more actions in response to detecting a failure of the procedure (step 1068), including: initiating a random access procedure on the second cell, transmitting a report to a network of the first cell, wherein the report indicates the unsuccessful switching of the SpCell to the second cell, or initiating a RRC connection re-establishment procedure (step 1070).

In various embodiments, the failure of the procedure is detected based on expiration of a timer.

In various embodiments, the method further comprises starting the timer in response to reception of the second signaling or transmission of a mobility complete message, wherein the mobility complete message is generated in response to the second signaling.

In various embodiments, the method further comprises stopping the timer in response to completion of the procedure.

In various embodiments, the failure of the procedure is detected based on quality of at least one reference signal associated with an Uplink (UL) grant on the second cell being lower than a threshold.

In various embodiments, the at least one reference signal is indicated via the first signaling or the second signaling.

In various embodiments, the UL grant is indicated via the first signaling or the second signaling.

In various embodiments, the failure of the procedure is detected based on number of SR transmissions on the second cell being equal to or larger than a maximum value.

In various embodiments, the method further comprises considering a time alignment information of the second cell to be invalid in response to detecting the failure of the procedure.

In various embodiments, the method further comprises switching to an initial or a default BWP of the second cell in response to detecting the failure of the procedure.

In various embodiments, the method further comprises discarding configured grant for the second cell in response to detecting the failure of the procedure.

In various embodiments, the random access procedure is for beam failure recovery.

In various embodiments, the method further comprises prioritizing selecting a third Cell indicated in the first signaling and/or the second signaling during the RRC connection re-establishment procedure.

In various embodiments, the failure of the procedure is detected based on number of transmissions for a mobility complete message on the second cell being equal to or larger than a maximum value.

Referring back to FIGS. 3 and 4, in one or more embodiments from the perspective of a UE, the device 300 includes a program code 312 stored in memory 310 of the transmitter. The CPU 308 could execute program code 312 to: (i) receive, from a first cell, a first signaling indicative of a configuration of at least a second cell; (ii) receive, from the first cell, a second signaling to switch a SpCell of the UE to the second cell, wherein the second signaling comprises at least one of a PDCCH signaling or a MAC CE; (iii) perform a procedure to switch the SpCell of the UE in response to the second signaling; (iv) perform one or more actions in response to detecting a failure of the procedure, including: (v) initiate a random access procedure on the second cell, transmit a report to a network of the first cell, wherein the report indicates the unsuccessful switching of the SpCell to the second cell, or initiate a RRC connection re-establishment procedure. Moreover, the CPU 308 can execute the program code 312 to perform all of the described actions, steps, and methods described above, below, or otherwise herein.

Any combination of the above concepts or teachings can be jointly combined or formed to a new embodiment. The disclosed details and embodiments can be used to solve at least (but not limited to) the issues mentioned above and herein.

It is noted that any of the methods, alternatives, steps, examples, and embodiments proposed herein may be applied independently, individually, and/or with multiple methods, alternatives, steps, examples, and embodiments combined together.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects, concurrent channels may be established based on pulse repetition frequencies. In some aspects, concurrent channels may be established based on pulse position or offsets. In some aspects, concurrent channels may be established based on time hopping sequences. In some aspects, concurrent channels may be established based on pulse repetition frequencies, pulse positions or offsets, and time hopping sequences.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of ordinary skill in the art would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer program product may comprise packaging materials.

While the invention has been described in connection with various aspects and examples, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method of a User Equipment (UE), comprising:
receiving, from a first cell, a first signaling indicative of a configuration of at least a second cell;
receiving, from the first cell, a second signaling to switch a Special Cell (SpCell) of the UE to the second cell, wherein the second signaling comprises at least one of a Physical Downlink Control Channel (PDCCH) signaling or a Medium Access Control (MAC) Control Element (CE);
performing a procedure to switch the SpCell of the UE in response to the second signaling; and
performing one or more actions in response to detecting a failure of the procedure, the one or more actions including:
initiating a random access procedure on the second cell;
transmitting a report to a network of the first cell, wherein the report indicates the unsuccessful switching of the SpCell to the second cell; or
initiating a Radio Resource Control (RRC) connection re-establishment procedure.

2. The method of claim 1, wherein the failure of the procedure is detected based on expiration of a timer.

3. The method of claim 2, further comprising starting the timer in response to reception of the second signaling or transmission of a mobility complete message, wherein the mobility complete message is generated in response to the second signaling.

4. The method of claim 2, further comprising stopping the timer in response to completion of the procedure.

5. The method of claim 1, wherein the failure of the procedure is detected based on quality of at least one reference signal associated with an Uplink (UL) grant on the second cell being lower than a threshold.

6. The method of claim 5, wherein the at least one reference signal is indicated via the first signaling or the second signaling.

7. The method of claim 5, wherein the UL grant is indicated via the first signaling or the second signaling.

8. The method of claim 1, wherein the failure of the procedure is detected based on number of Scheduling Request (SR) transmissions on the second cell being equal to or larger than a maximum value.

9. The method of claim 1, further comprising considering a time alignment information of the second cell to be invalid in response to detecting the failure of the procedure.

10. The method of claim 1, further comprising switching to an initial or a default Bandwidth Part (BWP) of the second cell in response to detecting the failure of the procedure.

11. The method of claim 1, further comprising discarding configured grant for the second cell in response to detecting the failure of the procedure.

12. The method of claim 1, wherein the random access procedure is for beam failure recovery.

13. The method of claim 1, further comprising prioritizing selecting a third Cell indicated in the first signaling and/or the second signaling during the RRC connection re-establishment procedure.

14. The method of claim 1, wherein the failure of the procedure is detected based on number of transmissions for a mobility complete message on the second cell being equal to or larger than a maximum value.

15. A User Equipment (UE), comprising:
a memory; and
a processor operatively coupled to the memory, wherein the processor is configured to execute program code to:
receive, from a first cell, a first signaling indicative of a configuration of at least a second cell;
receive, from the first cell, a second signaling to switch a Special Cell (SpCell) of the UE to the second cell, wherein the second signaling comprises at least one of a Physical Downlink Control Channel (PDCCH) signaling or a Medium Access Control (MAC) Control Element (CE);
perform a procedure to switch the SpCell of the UE in response to the second signaling; and
perform one or more actions in response to detecting a failure of the procedure, the one or more actions including:
initiate a random access procedure on the second cell;
transmit a report to a network of the first cell, wherein the report indicates the unsuccessful switching of the SpCell to the second cell; or
initiate a Radio Resource Control (RRC) connection re-establishment procedure.

16. The UE of claim 15, wherein the failure of the procedure is detected based on expiration of a timer, is detected based on number of Scheduling Request (SR) transmissions on the second cell being equal to or larger than a maximum value, or is detected based on number of transmissions for a mobility complete message on the second cell being equal to or larger than a maximum value.

17. The UE of claim 16, wherein the processor is further configured to execute program code to:
start the timer in response to reception of the second signaling or transmission of a mobility complete message, wherein the mobility complete message is generated in response to the second signaling; and
stop the timer in response to completion of the procedure.

18. The UE of claim 15, wherein the failure of the procedure is detected based on quality of at least one reference signal associated with an Uplink (UL) grant on the second cell being lower than a threshold, and wherein the at least one reference signal is indicated via the first signaling or the second signaling.

19. The UE of claim 15, wherein the processor is further configured to execute program code to:
in response to detecting the failure of the procedure, consider a time alignment information of the second cell to be invalid, switch to an initial or a default Bandwidth Part (BWP) of the second cell, and/or discard configured grant for the second cell.

20. The UE of claim 15, wherein the processor is further configured to execute program code to prioritize selecting a third Cell indicated in the first signaling and/or the second signaling during the RRC connection re-establishment procedure.
